(19) United States
(12) Patent Application Publication
(10) Pub. No.: US 2020/0274234 A1
(43) Pub. Date: Aug. 27, 2020

(54) System and Method for Making Electronic Structures and Antenna Coupled Terahertz Film with Nanoimprint or Roll-to-Roll

(71) Applicant: Redwave Energy, Inc., Boulder, CO (US)

(72) Inventors: Patrick K. Brady, Longmont, CO (US); Bradley Pelz, Boulder, CO (US); Zachary Thacker, Boulder, CO (US); Craig Perlov, Menlo Park, CA (US)

(21) Appl. No.: 16/796,881

(22) Filed: Feb. 20, 2020

Related U.S. Application Data
(60) Provisional application No. 62/808,275, filed on Feb. 20, 2019.
(60) Provisional application No. 62/816,907, filed on Mar. 11, 2019.
(60) Provisional application No. 62/817,489, filed on Mar. 12, 2019.

(51) Int. Cl. H01Q 1/24; H02N 11/00; G02B 1/00; G01N 21/3581

(52) U.S. Cl. CPC H01Q 1/248; G01N 21/3581; G02B 1/002; H02N 11/002

(57) ABSTRACT

An ACT film has a plurality of rectenna, each having having an antenna and a diode. The ACT film is manufactured using nanoimprint lithography and roll-to-roll processes. An imprint template is overlaid on a feedstock that has two metal layers separated by one or more oxide layers. The feedstock is etched to expose the lower metal layer. The lower metal layer is undercut to create a discontinuity in the lower metal layer to avoid a short to the diode in the rectenna. A metamaterial film is also made. To complete manufacture of the ACT film, the rectenna film and the metamaterial film are aligned to ensure the rectennas in the rectenna film are located over the holes in the metamaterials in the metamaterial film. Once aligned, the rectenna film and the metamaterial films are bonded together.

This application claims the benefit of the filing date of U.S. Provisional Application No. 62/808,275, filed Feb. 20, 2019, U.S. Provisional Application No. 62/816,907, filed Mar. 11, 2019, and U.S. Provisional Application No. 62/817,489, filed Mar. 12, 2019, all of which are hereby incorporated by reference herein in their entireties.

### BACKGROUND

### Field of the Invention

Embodiments of the present invention relate generally to structures and methods for forming electronic structures and antenna coupled terahertz films that comprise such structures in general, and structures for harvesting energy from electromagnetic radiation. More specifically, embodiments relate to nanostructures, metamaterials, Near Field Quantum Rectifiers (NFQ Rectifiers) or, alternately, rectennas and related methods and systems for harvesting energy from, for example, infrared, near infrared and visible spectrums and capturing millimeter waves and Terahertz energy, and to films comprising such structures.

### Background of the Invention

There is an immediate and great need for inexpensive renewable energy in the world right now. Ironically, there is an abundance of energy available in the form of sunlight and heat but using it to support the needs of society requires it to be converted into electrical form.

Low temperature waste heat is abundant and generally. Generally, such low temperature waste heat is found in large volume form, for instance, flue gas stacks or heated waste water. Harvesting volumes of gas or fluid requires large surface area contact with films created for this purpose. Harvesting sources of heat into usable electrical power is especially desirable at low cost. Low cost manufacturing techniques are then of importance to the proliferation of waste heat harvesting electronic films and systems.

### BRIEF SUMMARY OF THE INVENTION

Embodiments are directed to a system and method for making electronic components in general and NFQ Rectifiers, in particular, Embodiments use nanoimprint lithography and roll-to-roll (R2R) technology and films, such as antenna coupled terahertz films, that comprise such electronic and NFQ Rectifier structures. The technology of surfaces of paired nanoantenna and diode arrays present tremendous advantages for energy harvesting applications. In the area of waste heat recovery these systems are ideal since they can be tuned to the frequency spectra of the target source, have no moving parts, and are inexpensive to manufacture.

Embodiments described herein involve a method for fabricating electronic structures on films using nanoimprint lithography (NIL) and roll-to-roll (R2R). Developing NIL and R2R processes is expensive and time consuming. Reductions in the complexity or number of steps in a process translate to significant process development cost savings as well as reduced manufacturing cost. One such reduction, as described herein, involves an etched undercut of a key structural element in a multilevel stack.

If not made monolithically, due to the nano-scale size of the devices being manufactured, alignment is a key issue in NIL and R2R processes. Alignment of multiple structures can be assured using self aligned imprint lithography (SAIL). In the SAIL process, all device elements are assembled together in an imprint tool. A liquid polymer or monomer is applied to a substrate and the tool is pressed into the liquid. Rollers or other mechanical tools bring the substrate, liquid and imprint tool together. The liquid is cured with UV or heat and the imprint tool is separated from the cured polymer/monomer (hereinafter “polymer”).

Optimally, the NIL and R2R process of creating NFQ Rectifiers is a subtractive process. While it is possible to add layers or materials, in general the process is simplest if it is purely subtractive. In one embodiment of the invention, a substrate is coated with all the materials required to arrive at the finished component. This coated substrate is called a feedstock or a feedstock stack. For example, in making an NFQ Rectifier, a metal, at least one thin oxide, and a top metal are deposited on a substrate to create the feedstock. In an embodiment, the feedstock substrate is a substrate that can be used in roll-to-roll processes.

In an embodiment, the imprint polymer is deposited on the surface and etching of the imprinted structures and exposed feedstock layers proceeds step by step. Differential etches make it possible to selectively etch the polymer structure, metal, or oxide of the feedstock. In one embodiment, an NFQ Rectifier structure contains two metal layers separated by at least one oxide layer. The bottom metal is etched to form a left antenna leaf. The top metal is etched to form a right antenna leaf. An overlap area in the middle of the device forms a diode. In this embodiment, the simple subtraction of layers does not separate the right antenna from the lower metal below and, thus creates a short to the diode.

Undercutting the lower metal disconnects the lower metal to solve this shorting problem. The undercutting saves numerous other steps and simplifies the process significantly. In an embodiment, the undercut is performed with a wet etch of the metal and is enabled by placement of an impression, also referred to as a depression, structure in the imprint tool at the point where the undercut is desired.

Important elements for this undercut process to work are: an impression structure in the imprint tool at the region of undercut; an undercut region of narrower width than surrounding structures; and a wet etch or other isotropic etch capable of selectively removing material from beneath other permanent layers. In one embodiment of this approach, a wet etchant is used whose lateral etch rate is a function of the etchant temperature. In this manner, the lateral etch rate for the undercut is controlled by setting and maintaining a prescribed etchant temperature.

### BRIEF DESCRIPTION OF THE DRAWINGS

FIG. 1 illustrates a nanoimprint multilevel template on top of a feedstock stack according to an embodiment.

FIG. 1A illustrates an exemplary feedstock on a substrate and polymer nanoimprint tool layer according to an embodiment.

FIG. 1B illustrates an exemplary feedstock on a substrate and polymer nanoimprint tool layer according to a second embodiment.

FIG. 1C illustrates an exemplary feedstock on a substrate and polymer nanoimprint tool layer corresponding according to the second embodiment.

FIG. 1D is a cross section of FIG. 1C taken at line A-A′.

FIG. 2 illustrates a nanoimprint multilevel template on top of a feedstock stack after an initial de-scum etch according to an embodiment.

FIG. 2B illustrates a nanoimprint multilevel template on top of a feedstock stack after an initial de-scum etch according to a second embodiment.

FIG. 2C is a cross section of FIG. 2B taken at line B-B′.

FIG. 3 illustrates a nanoimprint multilevel template on top of a feedstock stack after an etch removing metal M2 and diode oxides in a depression region according to an embodiment.

FIG. 3B illustrates a nanoimprint multilevel template on top of a feedstock stack after an etch removing metal M2 and diode oxides in a depression region according to a second embodiment.

FIG. 3C is a cross section of FIG. 3B taken at line C-C′.

FIG. 4 illustrates a nanoimprint multilevel template on top of a feedstock stack after a passivation oxide is deposited according to an embodiment.

FIG. 4B illustrates a nanoimprint multilevel template on top of a feedstock stack after a passivation oxide is deposited according to a second embodiment.

FIG. 4C is a cross section of FIG. 4B taken at line D-D′.

FIG. 5 illustrates a nanoimprint multilevel template on top of a feedstock stack after a directional etch removes passivation oxide on horizontal surfaces according to an embodiment.

FIG. 5B illustrates a nanoimprint multilevel template on top of a feedstock stack after a directional etch removes passivation oxide on horizontal surfaces according to a second embodiment.

FIG. 5C is a cross section of FIG. 5B taken at line E-E′.

FIG. 6 illustrates a nanoimprint multilevel template on top of a feedstock stack after a wet etch removes the bottom metal in a depression region while also creating an undercut in the bottom metal according to an embodiment.

FIG. 6B illustrates a nanoimprint multilevel template on top of a feedstock stack after a wet etch removes the bottom metal in a depression region while also creating an undercut in the bottom metal according to a second embodiment.

FIG. 6C is a cross section of FIG. 6B taken at line F-F′.

FIG. 7 illustrates a nanoimprint multilevel template on top of a feedstock stack after an etch to remove the sidewall oxides left from passivation according to an embodiment.

FIG. 8 illustrates a transparent dimensional drawing with the nanoimprint multilevel template omitted for clarity to show the undercut according to an embodiment.

FIG. 9 illustrates a nanoimprint multilevel template on top of a feedstock stack after top layer of polymer is removed by an etch according to an embodiment.

FIG. 9B illustrates a nanoimprint multilevel template on top of a feedstock stack after top layer of polymer is removed by an etch according to a second embodiment.

FIG. 9C is a cross section of FIG. 9B taken at line G-G′.

FIG. 10 illustrates a nanoimprint multilevel template on top of a feedstock stack after an etch removes the feedstock stack outside of the remaining nanoimprint multilevel template layers according to an embodiment.

FIG. 10B illustrates a nanoimprint multilevel template on top of a feedstock stack after an etch removes the feedstock stack outside of the remaining nanoimprint multilevel template layers according to a second embodiment.

FIG. 10C is a cross section of FIG. 10B taken at line H-H′.

FIG. 11 illustrates a nanoimprint multilevel template on top of a feedstock stack after removing layer of the nanoimprint multilevel template according to an embodiment.

FIG. 11B illustrates a nanoimprint multilevel template on top of a feedstock stack after removing layer of the nanoimprint multilevel template according to a second embodiment.

FIG. 11C is a cross section of FIG. 11B taken at line I-I′.

FIG. 12 illustrates a nanoimprint multilevel template on top of a feedstock stack after etching metal M2 according to an embodiment.

FIG. 13 illustrates a nanoimprint multilevel template on top of a feedstock stack after removing remaining section of layer of the nanoimprint multilevel template according to an embodiment.

FIG. 13B illustrates a nanoimprint multilevel template on top of a feedstock stack after removing remaining section of layer of the nanoimprint multilevel template according to a second embodiment.

FIG. 13C is a cross section of FIG. 13B taken at line J-J′.

FIG. 14 illustrates a transparent and exploded dimensional drawing of the final structures including undercut 800 according to an embodiment.

FIG. 15 illustrates a structure that comprises an electroplating template or imprint pattern for the electroplating step in making a metamaterial according to an embodiment.

FIG. 16 illustrates a structure having an imprint pattern for making a metamaterial after a seed layer is deposited according to an embodiment.

FIG. 17 illustrates imprint pattern features that have been completely plated by a plating material 1702 such as copper according to an embodiment.

FIG. 18 illustrates a metamaterial comprising copper with a surface of period holes facedown with a substrate bonded to an opposite side of the copper according to an embodiment.

FIG. 19 illustrates a finalized metamaterial that has been flipped to illustrate the metamaterial has a surface with a periodic arrangement of holes according to an embodiment.

FIG. 20 illustrates an exemplary completed structure standoff structures have been added to metamaterial surface according to an embodiment.

FIG. 21 illustrates a way obtaining Moiré fringes, that is, rotation between two sets of grating lines, according to an embodiment.

FIG. 22 illustrates an exemplary rectenna alignment mark for a rectenna film that comprises 4 sets of gratings with alternative pitches □₁ and □₂, and an exemplary metamaterial alignment mark for a corresponding metamaterial film that comprises 4 sets of gratings with alternating pitches □₁ and □₂ according to an embodiment.

FIG. 23 illustrates coarse alignment of a rectenna film and a metamaterial film using Moiré fringes wherein the offset in the x-direction and the offset in the y-direction are less than or equal to □₁ according to an embodiment.

FIG. 24 illustrates fine alignment of a rectenna film and a metamaterial film in the x-direction using Moiré fringes according to an embodiment.

FIG. 25 illustrates fine alignment of a rectenna film and a metamaterial film in the y-direction using Moiré fringes according to an embodiment.

FIG. 26 is a schematic of an alignment system for aligning a rectenna film and a metamaterial film according to an embodiment.

FIG. 27 is a schematic diagram of an exemplary roll-to-roll system that incorporates an alignment system configured to operate in a roll-to-roll environment according to an embodiment.

FIG. 28 is a schematic of an exemplary system for aligning a metamaterial film and a rectenna film according to an embodiment using power output signature alignment according to an embodiment.

FIG. 29 is a flow chart for process for creating a rectenna film comprising a plurality of rectenna according to an embodiment.

FIG. 30 is a flow chart for a process that creates a metamaterial film comprising a plurality of metamaterials according to an embodiment.

FIG. 31 is a flow chart for a process for final product assembly of the rectennas coupled with the metamaterials according to an embodiment.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles herein may be applied to other embodiments. Thus, the present invention is not intended to be limited to the embodiments shown, including any limitations by any dimensions included in the figures, but is to be accorded the widest scope consistent with the principles and features described herein. The drawings are not drawn to scale. Any dimensions included in the figures are merely as exemplary an exemplary embodiment for the feature they apply to, and are not intended to be limiting, to indicate scale, or to be considered relative to any other feature in the drawings.

An Antenna Coupled Terahertz film (“ACT film”) is manufactured using roll-to-roll manufacturing built around nanoimprint lithography. The ACT film comprises two subassemblies: (1) a rectenna or NFQ rectifier film and (2) a metamaterial film. In an embodiment, the metamaterial is tuned to the resonating frequency of the antenna of the rectenna. In an embodiment, a NFQ Rectifier film comprises a roll-to-roll film substrate upon which a plurality of NFQ Rectifiers is manufactured. In an embodiment, a metamaterial film comprises a roll-to-roll substrate upon which a plurality of metamaterials is manufactured. To complete manufacturing of the ACT film, the rectenna and metamaterial films are aligned to ensure the rectenna are locate over the holes in the metamaterial and then bonded together.

The metamaterial (described below) comprising the metamaterial film is tuned to the frequencies expected for energy harvesting. In this case, the metamaterial is tuned to frequencies in the Terahertz (THz) range associate with heat. More details concerning the rectenna and metamaterial can be found in U.S. patent application Ser. No. 14/745,299, filed Jun. 19, 2015, entitled, “System and Method for Converting Electromagnetic Radiation to Electrical Energy Using Metamaterials,” (the “'299 patent application”) and U.S. patent application Ser. No. 15/602,051, filed Sep. 14, 2017, entitled “Structures, System and Method for Converting Electromagnetic Radiation to Electrical Energy Using Metamaterials, Rectennas and Compensation Structures,” (the “'051 patent application”) both of which are hereby incorporated by reference herein in their entireties.

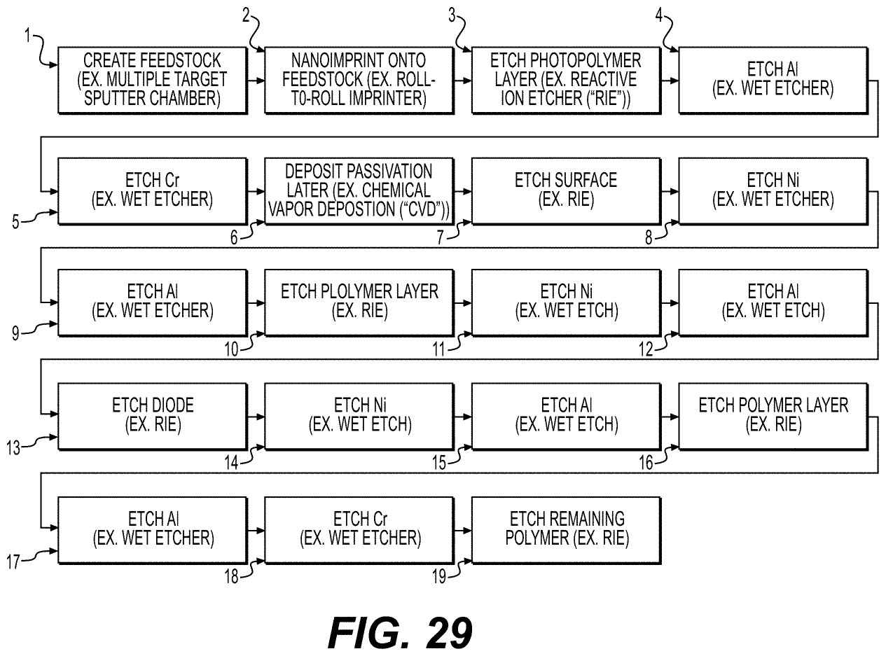

In an embodiment, manufacture of an ACT film incorporates a number of process steps as summarized below in Table 1 and in the process flow chart of FIGS. 29-31. The sub-assembly step numbers in Table I correspond to the step numbers in the flow charts of FIGS. 29-31.

TABLE 1
ACT film Manufacturing Process Summary

| | | | | Sub Assembly |
|---|---|---|---|---|
| | | | | Process Flow |
| | | SA-1 | SA-2 | Steps (See |
| | Primary Process Type | Rectenna | MetaMaterial | FIGS. 29-31) |
| | Create Rectenna Sub | | | |
| | Assembly (SA-1) | | | |
| 1 | Feedstock Deposition | | | 1 |
| 2 | NIL-Imprinting | | | 2 |
| | Photopolymer on | | | |
| | Feedstock | | | |
| 3 | Dry Etch (Reactive | | | 3, 7, 10, 13, |
| | Ion Etch (RlE)) | | | 16, 19 |
| 4 | CVD Chemical Vapor | | | 4, 5, 8, 9, |
| | Deposition | | | 11, 12, 14, |
| | | | | 15, 17, 18 |
| 5 | Wet Etch | | | |
| 6 | Create Metamaterial | | | |
| | Sub Assembly (SA-2) | | | |
| | NIL on metamaterial | | | 3001 |
| | Seed Layer Deposition | | | 3002 |
| | Cu Electroplate | | | 3003 |
| | Laminate final | | | 3004 |
| | Substrate | | | |
| | Remove Temporary | | | 3005 |
| | Substrate - Delaminate | | | |
| | Pattern Standoff | | | 3006 |
| | Pillars (NIL) | | | |
| 7 | Align- Assemble - | | | 3101, 3102, |
| | Laminate SA-1 | | | 3103 |
| | Rectenna and SA-2 | | | |
| | Metamaterial | | | |

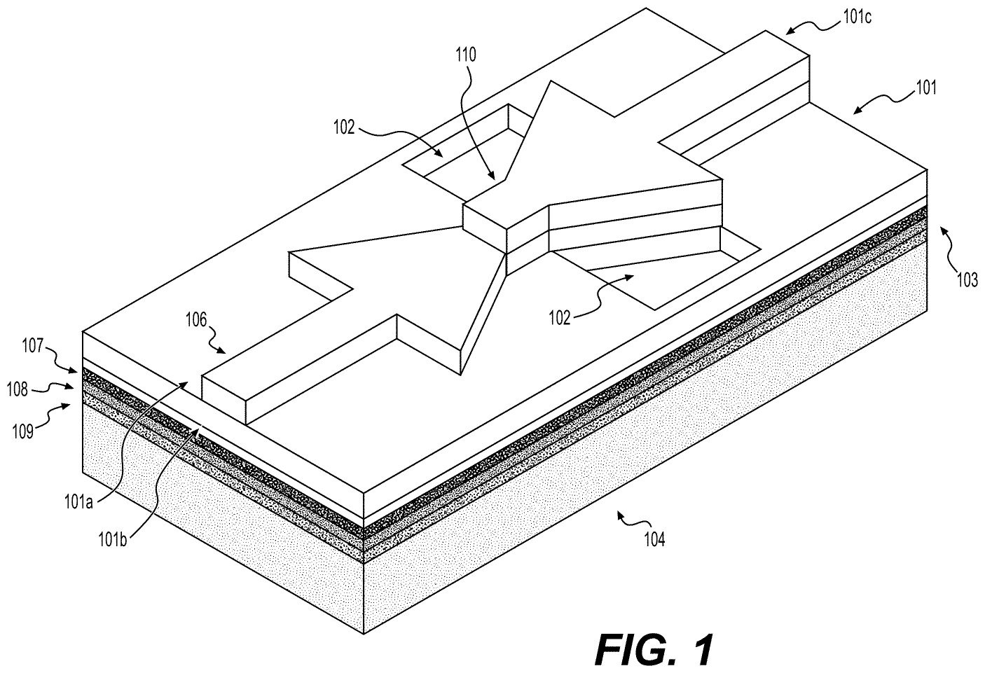

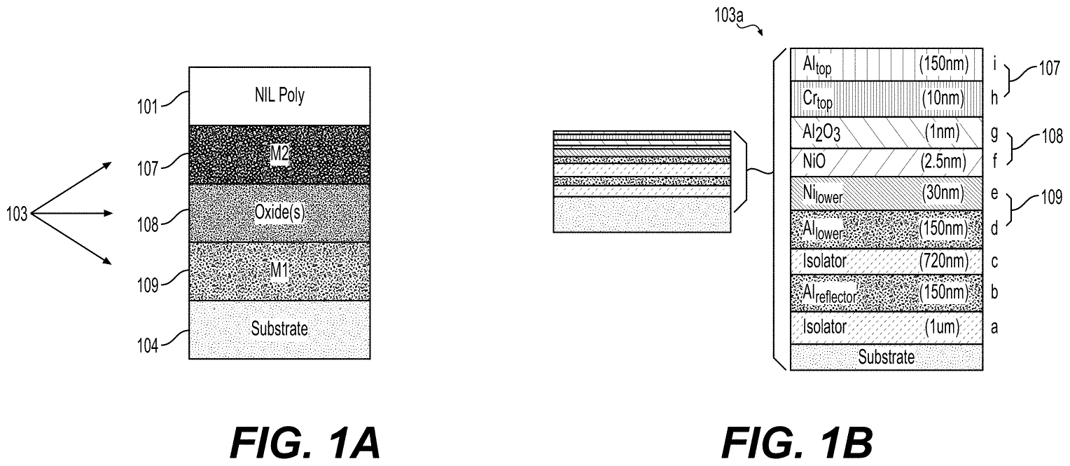

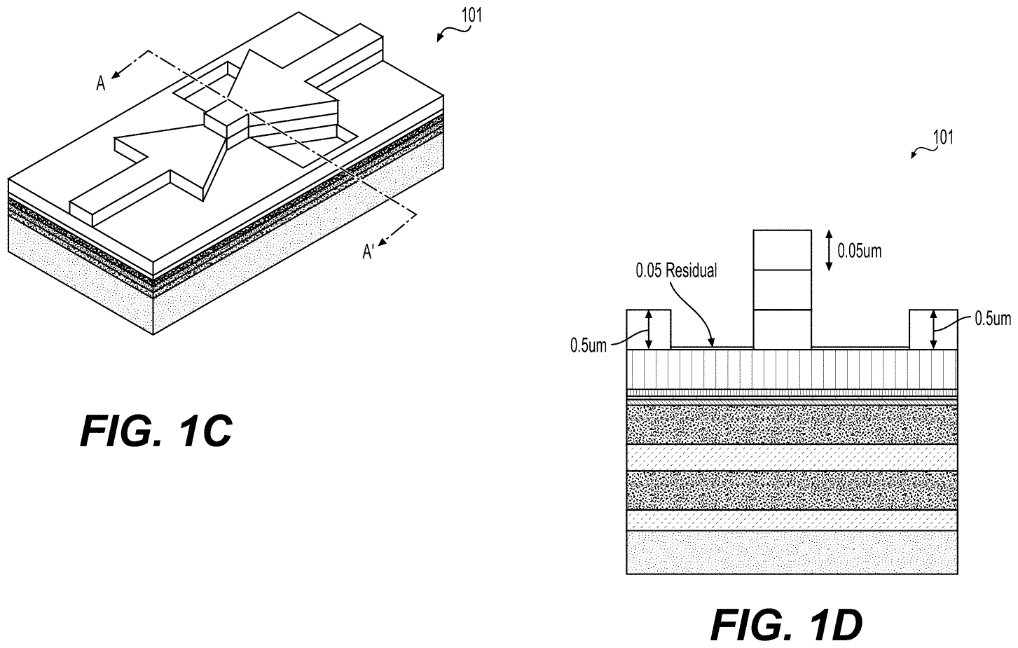

To begin manufacture of an ACT film according to an embodiment, a feedstock is created. FIGS. 1A and 1B, illustrate exemplary feedstocks 103 and 103a respectively. Feedstock 103 is an exemplary feedstock for manufacture of a rectenna 1304. The rectenna subassembly film comprises a plurality of such rectennas 1304. Feedstock 103a is an exemplary feedstock for manufacture of a rectenna with a reflector.

As shown in FIG. 1B, to create feedstock 103a, on surface treated stainless steel (or other) substrate 104a according to another embodiment, the following layers (with exemplary thicknesses) are sputter deposited:

(a) 1 um SiO₂ isolation layer (for conductive substrate only)

(b) 150 nm Al

(c) 720 nm Si0₂ isolation layer

(d) 150 nm Al

(e) 30 nm Ni

(f) 2.5 nm NiOx

(g) 1 nm Al₂0₃

(h) 10 nm Cr

(i) 150 nm Al

In the description that follows, as shown for example in FIG. 1B, for ease of explanation and because manufacture of a rectenna and metamaterial is not limited to the above materials for a feedstock, reference is made to a general substrate 104, a general first metal 109, M1, a general second metal 107, M2, and general one or more oxides 108 for ease of explanation. Using this convention, in the exemplary feedstock 103a, substrate 104 is made from silicon oxide. Metal 107, M2, comprises a layer of nickel and a layer of aluminum. Metal 109, M1, comprises a layer of chromium and a layer of aluminum. Oxides layers 108 comprise two oxide layers, nickel oxide and aluminum oxide. As such, using feedstock 103a will result in a rectenna device having a metal-insulator-insulator-metal (MIIM) diode.

Feedstocks 103 and 103a can be created in several passes. Referring to FIG. 1B, expositions of the substrate (a), reflector (b), and isolator (c) should be accomplished in a single pass under vacuum. Note: at this point vacuum may be broken. Next depositions of metal 107, M1, (d) and (e), oxides (f) and (g), and metal 109, M2 (h) and (i) must then be completed without breaking vacuum. Precise control of metals and oxides is central to the diode function of the devices so breaking vacuum would expose materials to a source of oxygen and possibly corrupt the materials stack.

In an embodiment, the thin layers of the feedstock are amenable to sputter deposition without discontinuities. Creation of the feedstock is referred to as step 1 in the process flow chart of FIG. 29 and in Table 1.

There are a variety of substrate choices for ACT film processes. The best substrate will have good dimensional stability, smooth surface, low price and be heat tolerant. Table 2 lists candidate substrate materials in current order of desirability, along with pros and cons of each:

TABLE 2
Substrate candidate materials

| Substrate | Pro | Con |
|---|---|---|
| Stainless Steel | Low CTE | Weight |
| | Cost $1/m2 | 1 m width quality |
| | Can be polished | |
| | Dimensional Stability | |
| | Tolerance to High Temperature | |
| Kapton | Among Polymers - Good CTE | CTE not as good as |
| | | Stainless Steel |
| | Good Surface Finish | Cost $3/m2 |
| | Weight | Requires backside |
| | | coating |
| | Tolerant to 300 C. | |
| PET | Cost $1.50/m2 | Large CTE |
| | Weight | Poor dimensional |
| | | stability |
| | | Requires backside |
| | | coating |
| | | Poor Surface Finish |
| | | Poor tolerance to |
| | | high temperature |

After creation of the feedstock, such as feedstock 103 or 103a, a nanoimprint tool 101 is created by coating the feedstock with a uniform thickness of UV curable photopolymer. This can be accomplished with a reverse gravure coater or the like. In an embodiment, the coated feedstock is then imprinted using a patterned quartz roller, and UV light from within the quartz roller sets the polymer while it is in the nip between the imprint and backing roller. The imprinted feedstock then goes through a thermal or second UV curing stage to complete the cross-linking of the polymer.

In an embodiment, the final photopolymer is compatible with the wet metal etchants used in subsequent process steps. It must also be etched in an oxygen plasma and removable at the end of the process steps with an ashing or similar process. In an embodiment, the imprint step or layer height is about 0.5 microns. In an embodiment, the gravure coating is about 1 micron. Creation of nanoimprint tool 101 is referred to as step 2 in the process flow chart of FIG. 29 and in Table 1. FIGS. 1 and 1C illustrate an exemplary nanoimprint tool 101 on top of feedstock 103 and 103a respectively. FIG. 1D illustrates a cross section taken at line A-A′ in FIG. 1C of an exemplary embodiment for feedstock 103a.

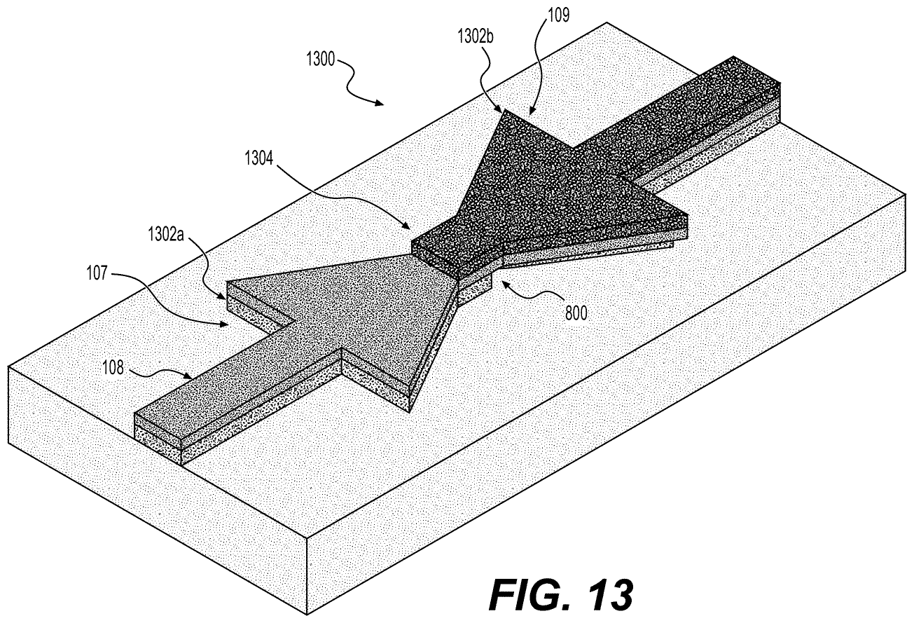

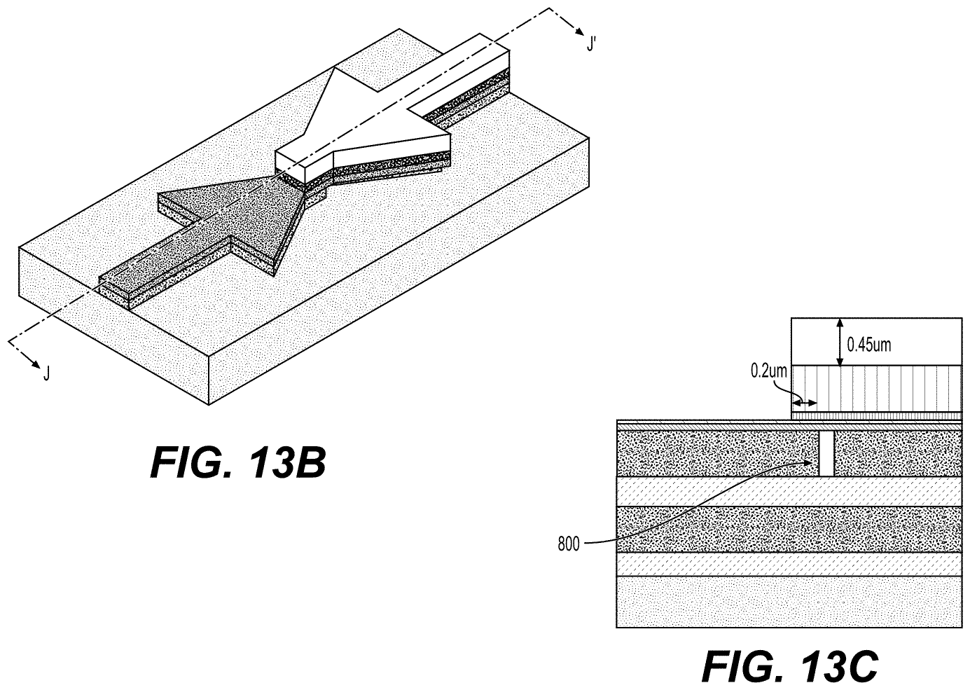

Referring to FIGS. 1 and 13, the first subassembly, which comprises a rectenna 1304, comprises a substrate 104, feedstock layers 103, and a nanoimprint tool 101. It is noted that alternatively, the feedstock may be referred to as including substrate 104 and/or nanoimprint tool 101.

Referring to FIG. 13, in an embodiment, a rectenna or NFQ rectifier 1300 is manufactured. In an embodiment, NFQ Rectifier 1300 comprises two antenna leaves 1302a and 1302b and a diode 1304. In operation, electric current is generated in antenna leaves 1302a and 1302b, and fed to a feed point at which diode 1304 is located. Diode 1304 operates to rectify the electric current generated in the antenna leaves, and thereby provide DC electric current, which can be used to power other devices.

Antenna leaf 1302a is made of a first metal 109, M1, and antenna leaf 1302b is made from a second metal 107, M2. Diode 1304 comprises metals M1 and M2 and one or more diode oxides 108. In an embodiment, metals M1 and M2 are multilayered. For instance, metal M1 is Aluminum with a thin layer of Nickel and metal M2 is a thin layer of Chrome with Aluminum on top. Such variations are important since the requirements of a metal used in an antenna differ from that of a diode. In an embodiment, metals M1 and M2 are the same metal.

Antenna metals typically need to be highly conductive at high frequency. Thus, in an embodiment, aluminum is the primary conduction metal in both metals M1 and M2. Metals in a metal-insulator-metal (MIM) diode or metal-insulator-insulator-metal (MIIM) diode are selected for their different work functions and how they establish barriers with oxides for desired tunneling and antisymmetric diode behavior. In an embodiment, diode 1304 includes one or more diode oxides 108, for example, NiO and Al2O3. For clarity in this example, the full stack of the feedback stock Al—Ni—NiO—Al2O3-Cr—Al. A reflector metal and isolation region can also be added as shown in FIG. 103a

Referring to FIG. 1, in an embodiment of the invention, a multilevel nanoimprint template 101 is combined with feedstock 103 on substrate 104 as shown in FIG. 1. In an embodiment, substrate 104 is a portion of a roll-to-roll film substrate. FIG. 1 shows just one of many repeating such structures comprising nanoimprint template and feed stock 103 on the substrate.

As shown in FIG. 1, in an embodiment, nanoimprint tool 101 comprises a number of layers 101a, 101b, and 101c. The number of layers corresponds to the number and kind of etches that will be required to make rectenna 1300. For example, in an embodiment, nanoimprint tool has 3 layers. Also as shown in FIG. 1, the layers of nanoimprint tool 101 have the shape of the desired rectenna 1300 to be made. For example, as shown in FIG. 1, nanoimprint too 101 comprises a layer having the shape of a first antenna leaf 111 that corresponds to antenna leaf 1302a or rectenna 1300, and a second antenna leaf 112 that corresponds to antenna leaf 1302b of rectenna 1300 as well as an overlapping area 110 that corresponds to diode 1304. Thus, in the embodiment illustrated, rectenna 1300 is a bow tie antenna.

In an embodiment, nanoimprint tool 101 is made from a polymer that can be selectively removed by etching. As described herein, manufacturing a rectenna 1300 involves alternative etches of specific features in a self-aligned imprint template.

FIG. 1A illustrates an exemplary feedstock 103 on a substrate 104 with a nanoimprint tool polymer 101. In an embodiment, feedstock 103 includes a first metal 109 placed on top of substrate 104 with one or more oxides 108 on top of first metal 109 and a second metal 107 placed on top of oxides 108.

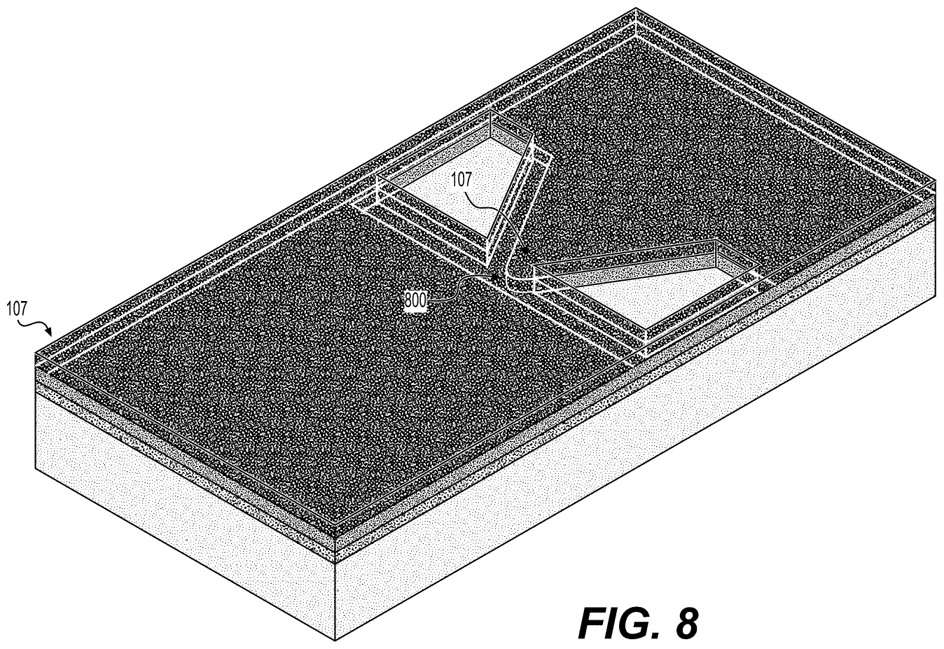

Depression, or alternately, impression, area 102 in imprint tool 101 allows wet chemical etch access to the area near area 110, which corresponds to diode 1304, where undercut 800 (see FIG. 8) will be formed. In an embodiment, the undercut etch takes place near the end of a sequence of etches described herein.

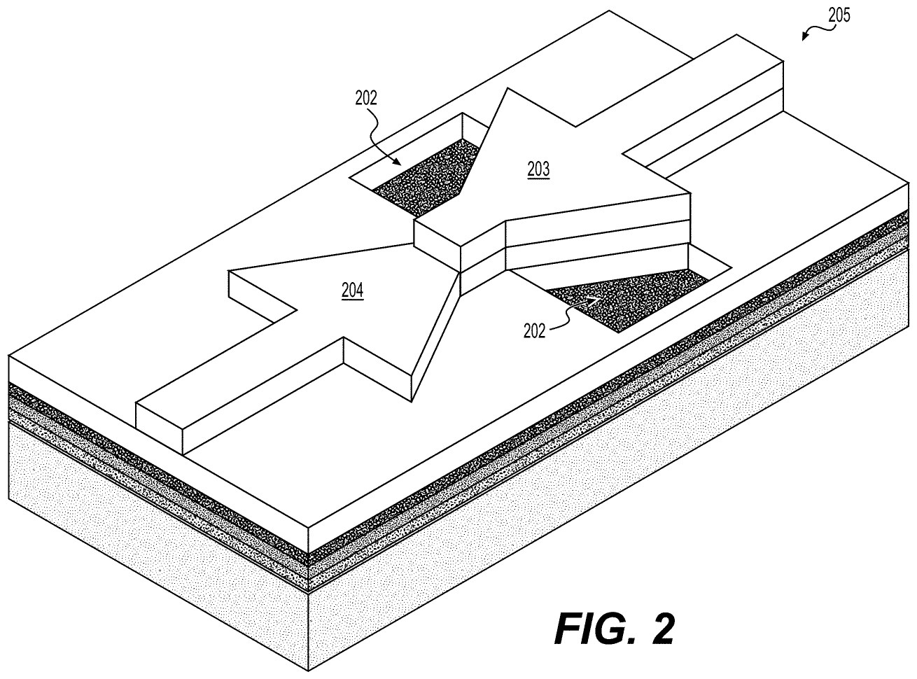

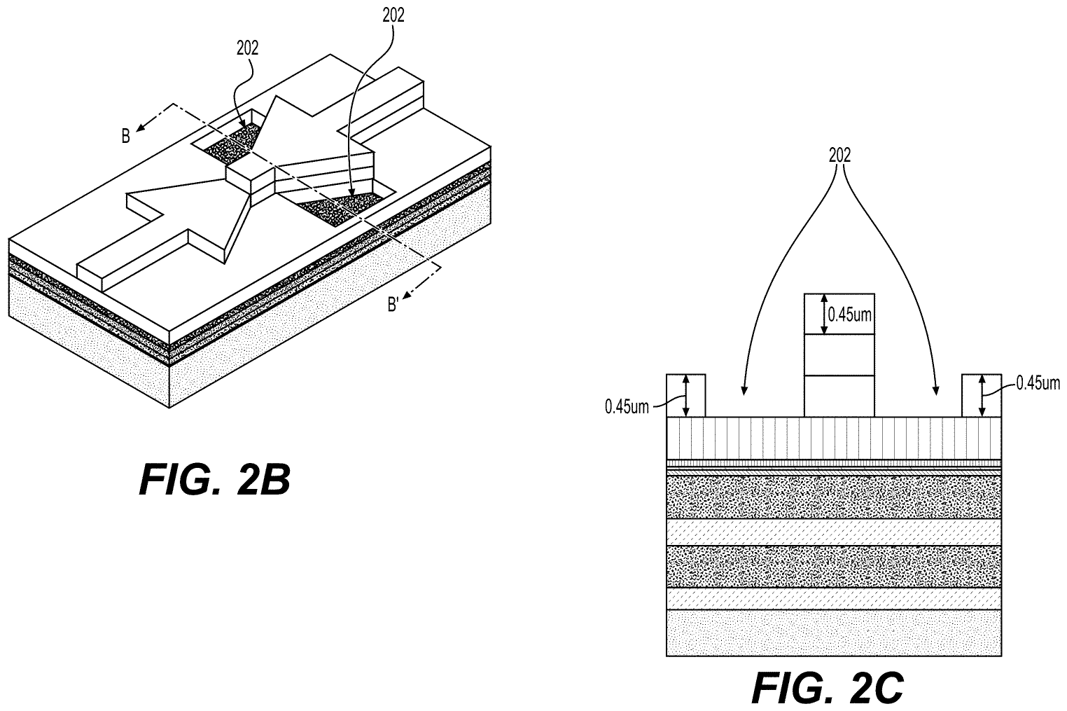

Referring to FIG. 2, a first etch, a de-scum etch, of nanoimprint template polymer 101 exposes metal 107, M2, in the region 202. Region 202 illustrates the result of the impression structure to form the undercut region. After the de-scum etch this impression structure is opened to expose M2. In an embodiment, the de-scum etch removes about 0.05 um residual imprint material and clears depression or via region 102. Oxygen plasma RIE with some CHF3 can be used to perform the de-scum etch.

Time depends on imprint process. In an embodiment, the etch time and process parameters are determined, and are influenced, by the specific polymer choice and, for this step, the thickness of the gravure coating selected in step 2. In an embodiment, the photopolymer etch time is 10 seconds or approximately 10 seconds. The de-scum etch is referred to as step 3 in the process flow chart of FIG. 29 and in Table 1. FIGS. 2 and 2B illustrate an exemplary nanoimprint tool 101 on top of feedstock 103 and 103a respectively. FIG. 2C illustrates a cross section taken at line B-B′ in FIG. 2B of an exemplary embodiment after the de-scum etch.

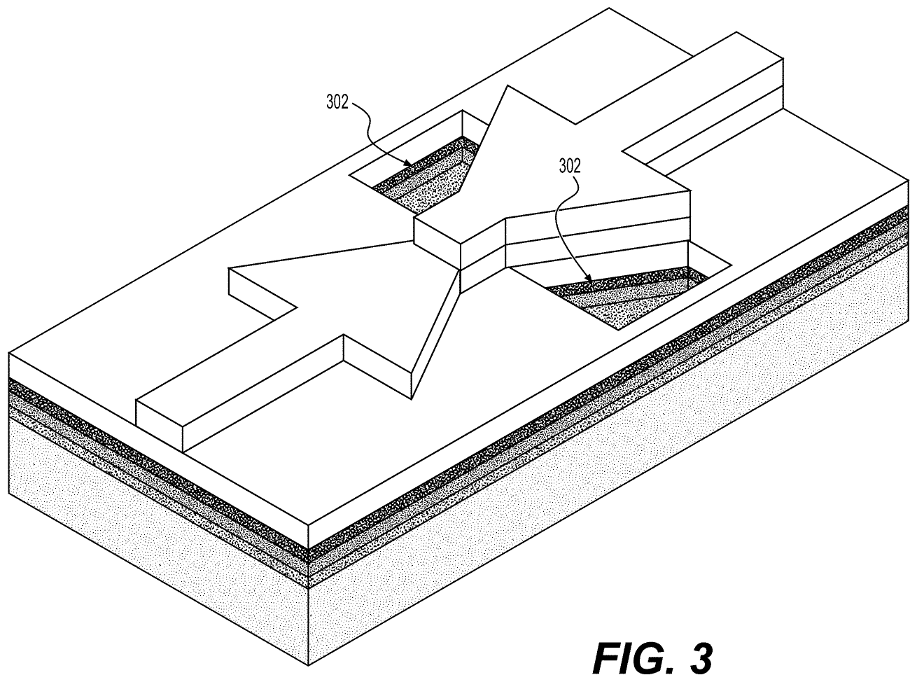

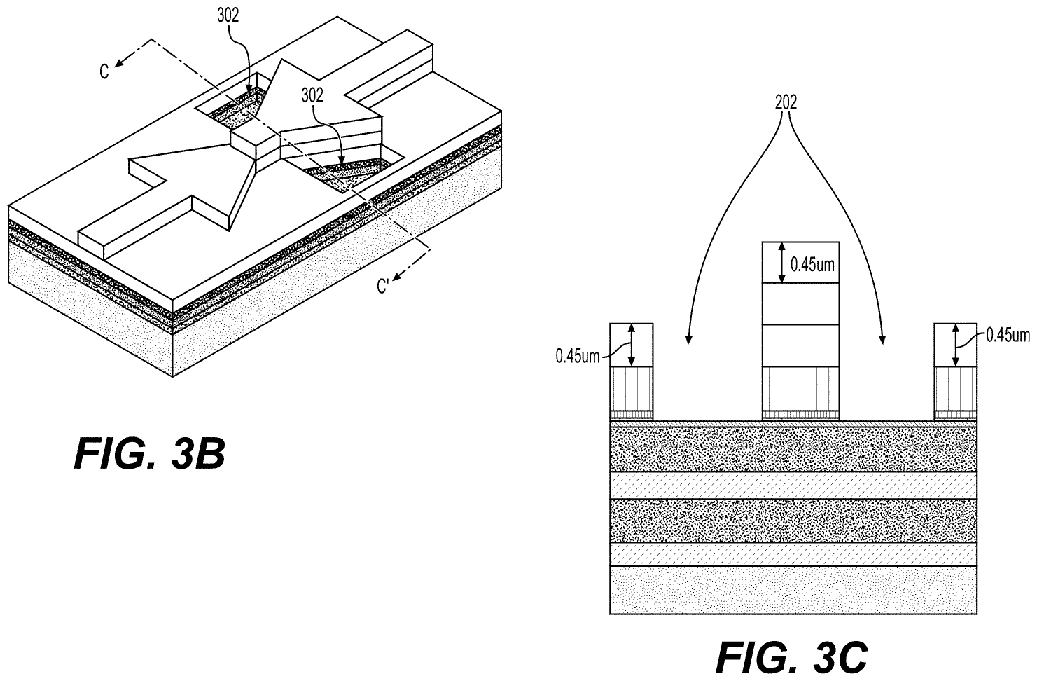

Next, as illustrated in FIG. 3, metal 107, M2, and diode oxides 108 are etched to expose metal 109, M1, in areas 302. Metal 109, M1, must be discontinuous between antenna leaf regions 111 and 112 to avoid a short to diode 110. The narrow region near diode area 110 is an ideal region for an undercut to create the required discontinuity.

For example, in an embodiment with a feedstock 103a, this etch removes 150 nm of top metal aluminum. (See, e.g., Al layer (i) of feedstock 103a in FIG. 1B) in via, 102. In an embodiment, the etch is a 30 C wet etch with an etchant such as Cyantek Al-12S. If a dip tank is used, the etchant must be stirred during the etch. In an embodiment, this metal, for example, Al, etch time is 30 seconds or approximately 30 seconds. In an embodiment, the photopolymer is unaffected by the etchant. This Al metal etch is referred to as step 4 in the process flow chart of FIG. 29 and in Table 1.

In addition, in an embodiment with a feedstock 103a, an etch is performed to remove the top Cr metal (See, e.g., Cr layer (h) of feedstock 103a in FIG. 1B) interface metal in the via, region 102. It an embodiment, this etch is a room temperature wet etch using a diluted etchant such as Cyantek Cr-14. In general such etchants are highly selective. In an embodiment, the Cr etch time is 10 seconds or approximately 10 seconds. In an embodiment, the aluminum etchant will stop on the chrome. It may be possible (but perhaps not desirable) to etch both metals in the same etchant. This Cr metal etch is referred to as step 5 in the process flow chart of FIG. 29 and in Table 1.

FIGS. 3 and 3B illustrate the result of etching metal 107, M2, and oxide layers 108 to expose metal 109, M1, in depression or via region 202 of feedstock 103a. FIG. 3C illustrates a cross section taken at line C-C′ in FIG. 3B of an exemplary embodiment after the metal 109, M2, and oxide layer 108 are etched.

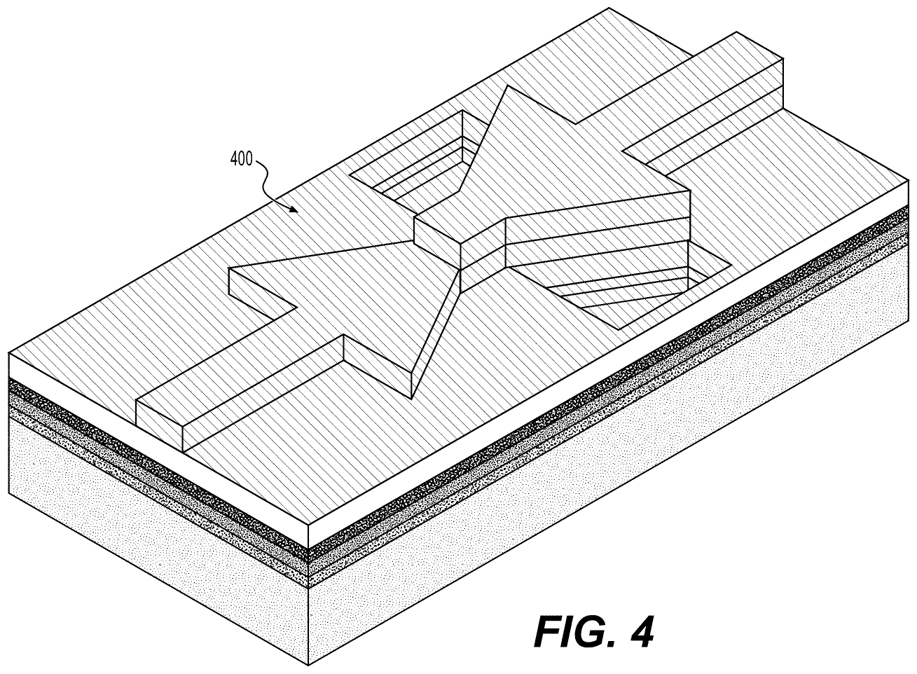

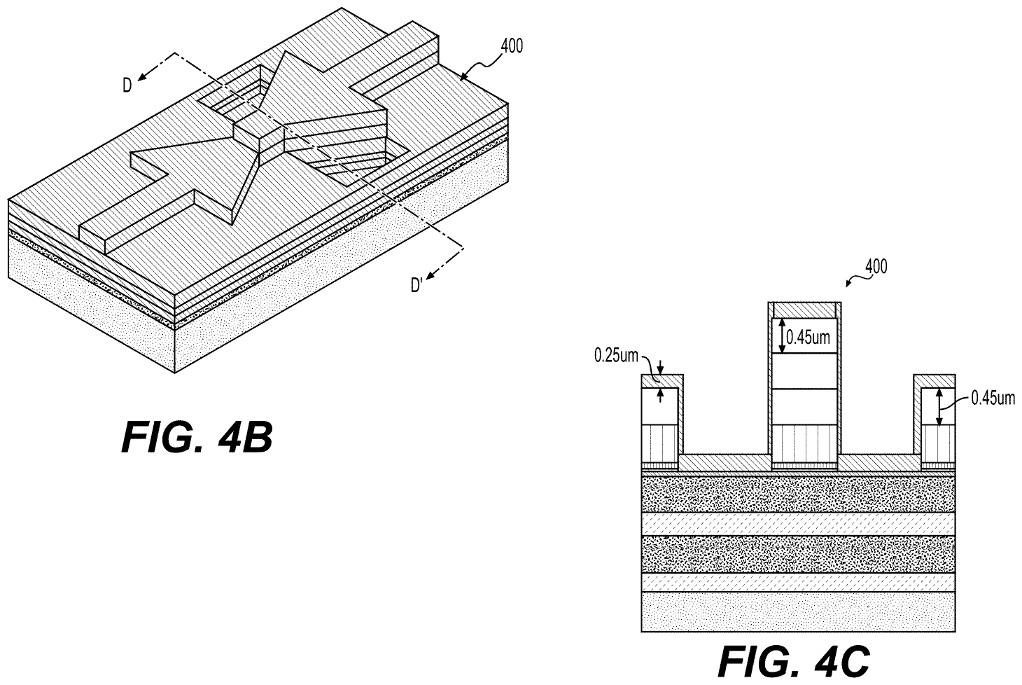

Next, in an embodiment, in a step of passivation as illustrated in FIG. 4, a layer of passivation oxide 400 is deposited over the entire structure including sidewalls. This passivation step is only necessary at this point if the etch between metal 109, M1, and metal 107, M2, is not selective. One such case is where the metal 109, M1, is the same as metal 107, M2.

In an embodiment, in the passivation step, a CVD layer is deposited as shown. It will cover all exposed surfaces, both vertical and horizontal. In an embodiment, the thickness and composition of the CVD layer is SiN at a thickness of 0.25 um. It is helpful that there be some visual contrast to monitor subsequent process steps. This passivation step is referred to as step 6 in the process flow chart of FIG. 29 and in Table 1. FIGS. 4 and 4B illustrate the result of applying the passivation oxide to feedstock 103a. FIG. 4C illustrates a cross section taken at line D-D′ in FIG. 4B after application of passivation layer.

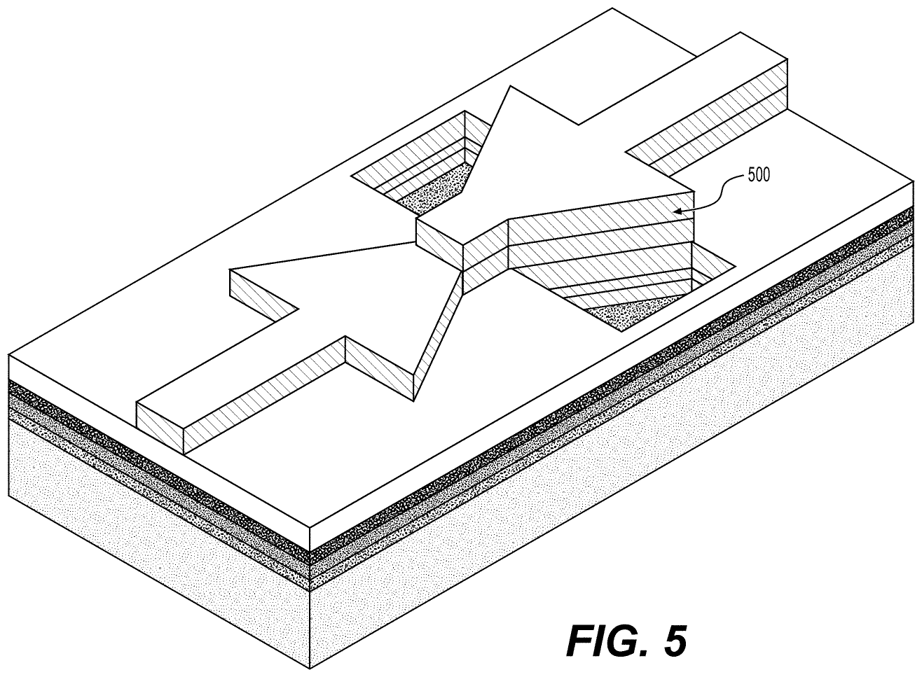

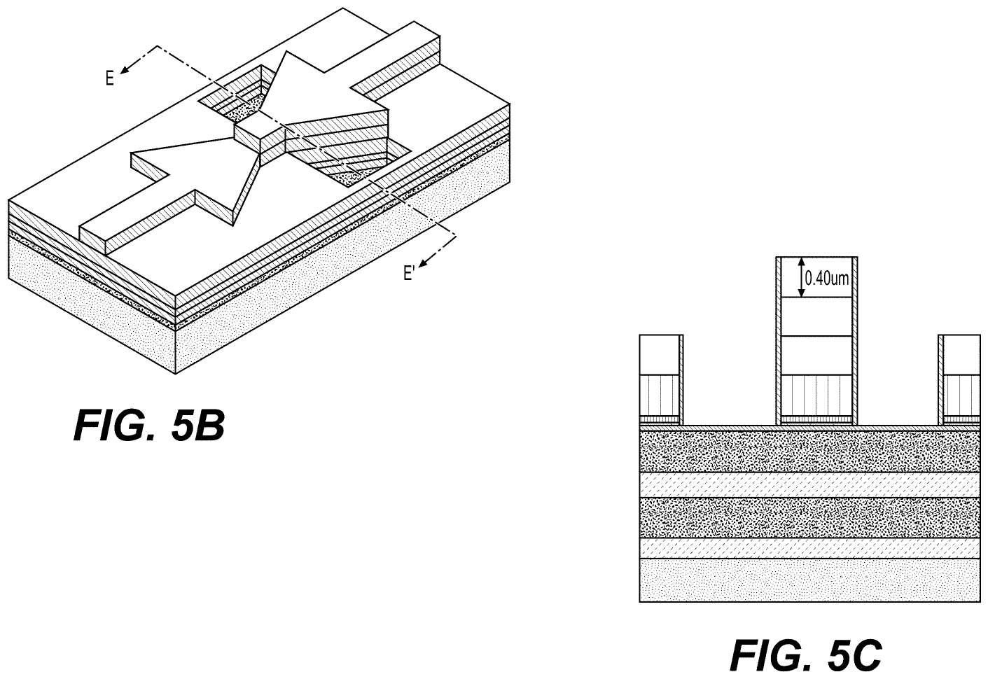

Next, as shown in FIG. 5, a directional etch of the passivation material leaves only sidewalls 500 coated. Such a directional etch can be accomplished, for example, in a reactive ion etcher (RIE) using oxygen and/or fluorine based gases. This RIE etch clears the horizontal passivation layer leaving the exposed edges of the top metal layer protected from the subsequent metal etch. In an embodiment, the RIE etch is performed using SF6. In an embodiment, the RIE etch time is in the range of 30 seconds to 1 minute. This directional etch step is referred to as step 7 in the process flow chart of FIG. 29 and in Table 1. FIGS. 5 and 5B illustrate the result of the directional etch step applied feedstock 103a. FIG. 5C illustrates a cross section taken at line E-E′ in FIG. 5B after application of passivation layer.

In embodiment using feedstock 103a, the Ni interface metal (See, e.g., layer (e) of feedstock 103a in FIG. 1B). Room temperature wet etch. In an embodiment, the Ni etch time is 10 seconds or approximately 10 seconds. This step may not be needed if the aluminum etchant also removes the nickel. A diluted version of Transene Ni etchant TFG is a can be used for this step, which is referred to as step 8 in the process flow chart of FIG. 29 and in Table 1.

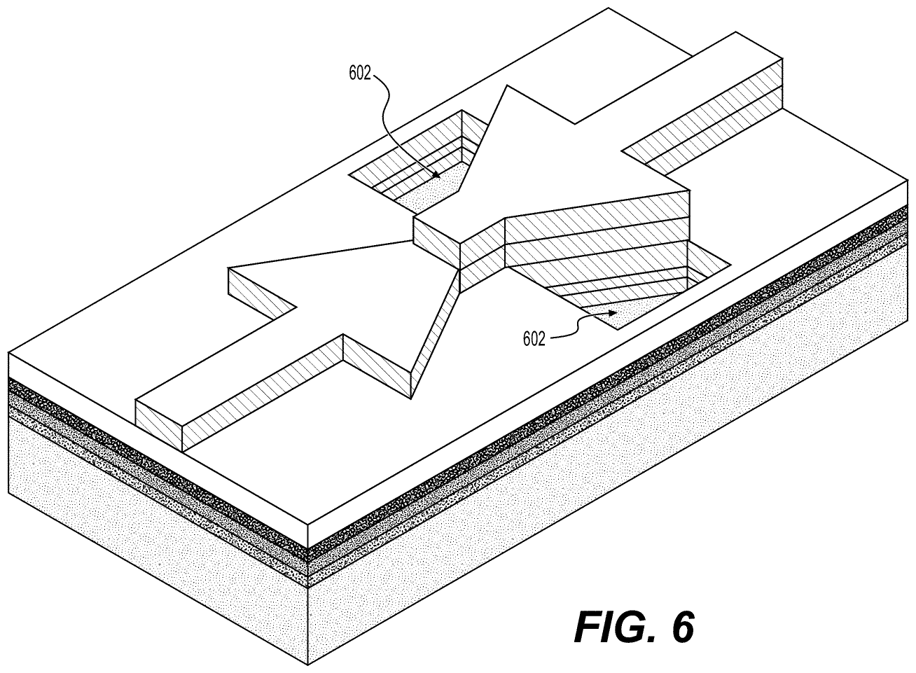

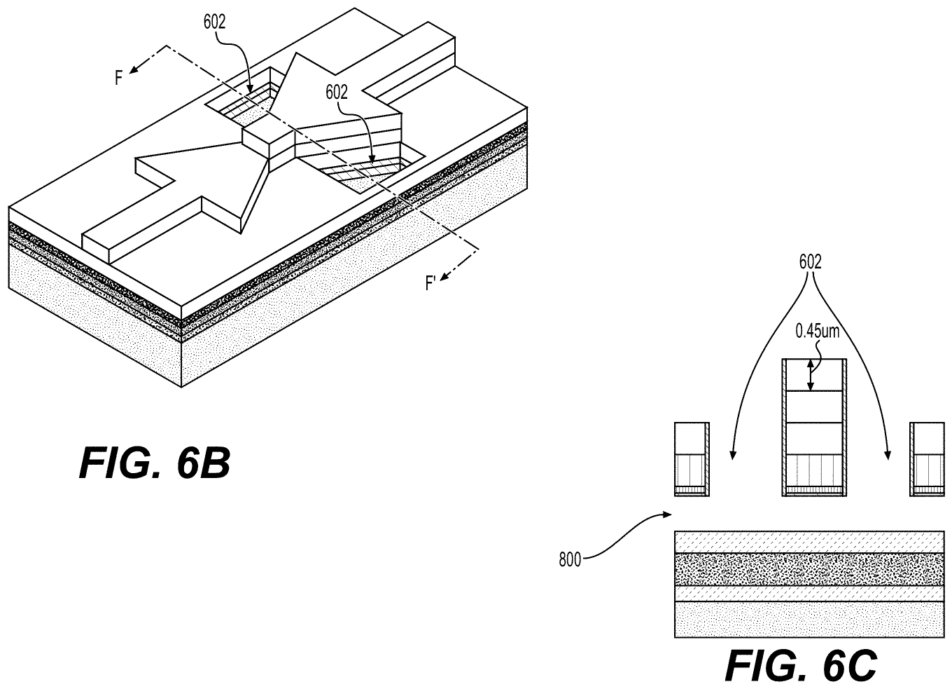

Next, as shown in FIG. 6, a wet etch removes the metal 109 M1 in the impression area 602. The wet etch also creates undercuts 800 in metal 109 M1 to remove the diode short. It can be seen that substrate 104 is visible through the depression area 602. The undercut is now complete, but several steps remain in the process.

The lateral wet etch that determines the undercut is carefully controlled by, for example, controlling the etchant temperature. Wet etchants of Al, for example, have a lateral etch rate that is highly temperature dependent. At temperatures above about 55° C. the lateral etch rate can be as large or larger than the vertical etch rate. Careful control of the temperature in this case is key to control of the undercut. The exact etch time is determined by the thickness of the metal, the length of undercut required and the temperature of the etchant. This undercut serves not only to isolate the metal M1 and metal M2 layers but also defines the area of the active diode device 110, which corresponds to diode 1304 of rectenna 1300. Defining the dimensions of diode 1304 with undercut methods is very important since it is often advantageous to create a small diode 1304 structure. The undercut method described makes it possible to exceed the small scale limit of the imprint technology used to create even smaller structures.

Wet etch of metal 107, M1, Al in the example of feedstock 103a (See, e.g., layer (d) of feedstock 103a in FIG. 1B). In an embodiment, the wet etch of metal 107, M1, Al in the exemplary feedstock 103a, is performed at about 40° C., and for 30 seconds or approximately 30 seconds. If using a dip tank, the etchant must be stirred during the etch process. The aluminum etchant must first cut through the 150 nm thickness of the aluminum and then the lateral etch begins. The lateral etch rate is a strong function of the temperature of the etchant. Even a 1-degree temperature change can greatly effect the lateral etch rate. In an embodiment, the lateral etch must extend 100 nm on each side of the via to isolate the active diode area (i.e. the diode area between the upper and lower antenna arms) in the final structure. Some over-etch at this point would be prudent to avoid shorting. This etch serves to define the location of one edge of the active diode so care must be taken to control this step. The state after etching is shown in the following two figures. In the second figure the photopolymer is not shown and the upper metal and diode layers are shown as semi-transparent.

This undercut etch is referred to as step 9 in the process flow chart of FIG. 29 and in Table 1. FIGS. 6 and 6B illustrate the result of etching metal 109, M2, and oxide layers 108 to expose metal 107, M1, in depression or via region 202 of feedstock 103a. FIG. 6C illustrates a cross section taken at line F-F′ in FIG. 6B of an exemplary embodiment after the metal 109, M2, and oxide layer 108 are etched.

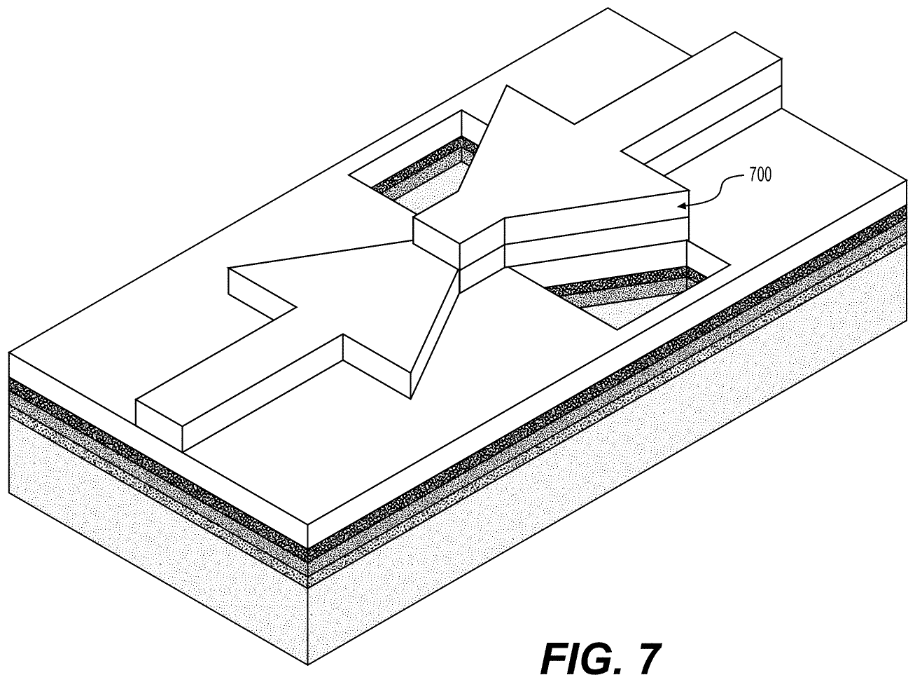

Next, as shown in FIG. 7, residual passivation oxide 400 that is on the sidewalls of various features is removed, which leaves the remaining NIL polymer 101 on top of feedstock 103. This step may not be required if the subsequent metal M2 and diode etches simultaneously remove the sidewall layer. At this point a second passivation might be desirable to reduce further undercut. The exact location of the via will be determined by the specific nature and performance of the undercut and could be relocated if necessary.

FIG. 8 illustrates a transparent view of the assembly after etching to create undercut 800 with the imprint polymer removed for visibility. As can be seen, metal 109, M1, is undercut (discontinuous) beneath a continuous metal, 107, M2. At this point a second passivation step can be added to restrict to add a passivation oxide that will restrict further development of the undercut during subsequent etches of the metal 109, M1, layer.

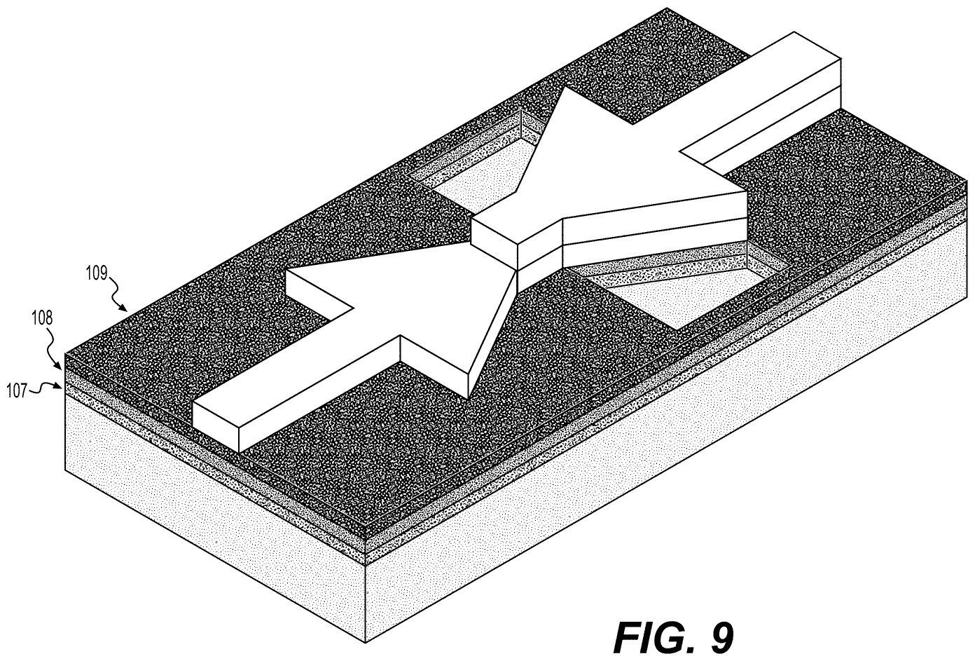

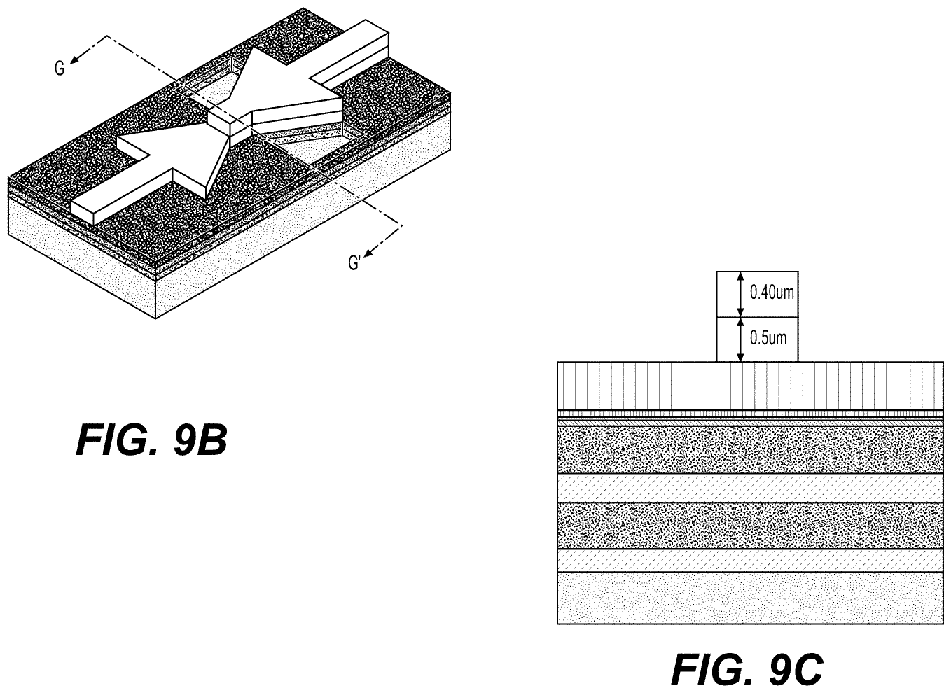

Next, as illustrated in FIG. 9, a layer 205 of the polymer nanoimprint template 101 is removed to expose metal 107, M2. Removal of the imprint layer, exposes the outline of the device. In an embodiment, oxygen plasma RIE, perhaps with some CHF3, is used. Time depends on step height. In an embodiment, the photopolymer etch time is 1 minute or approximately 1 minute.

The step of removing the imprint layer is referred to as step 10 in the process flow chart of FIG. 29 and in Table 1. FIGS. 9 and 9B illustrate the result of removing the imprint layer. FIG. 9C illustrates a cross section taken at line F-F′ in FIG. 9B of an exemplary embodiment after the metal 109, M2, and oxide layer 108 are etched.

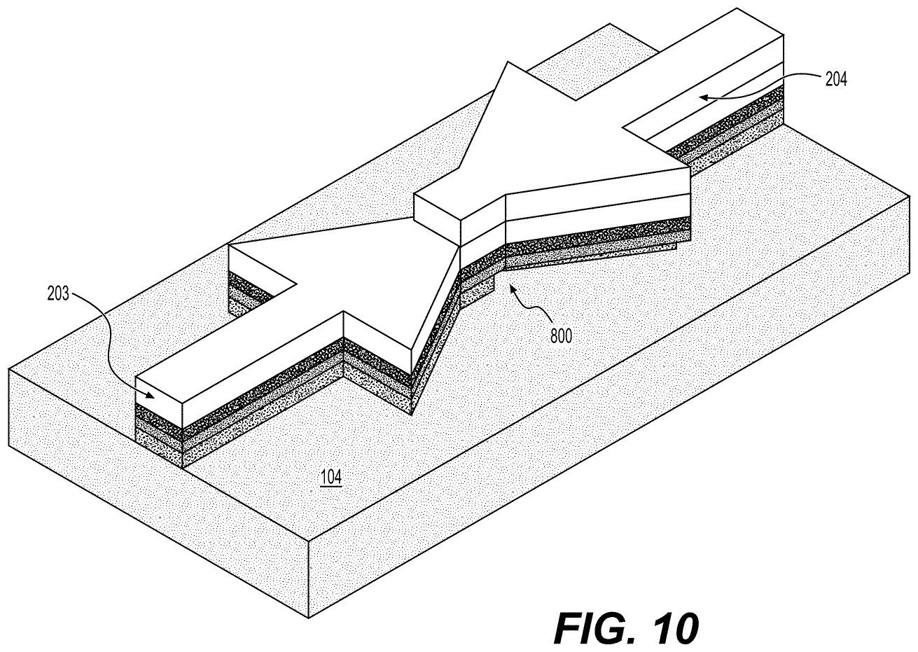

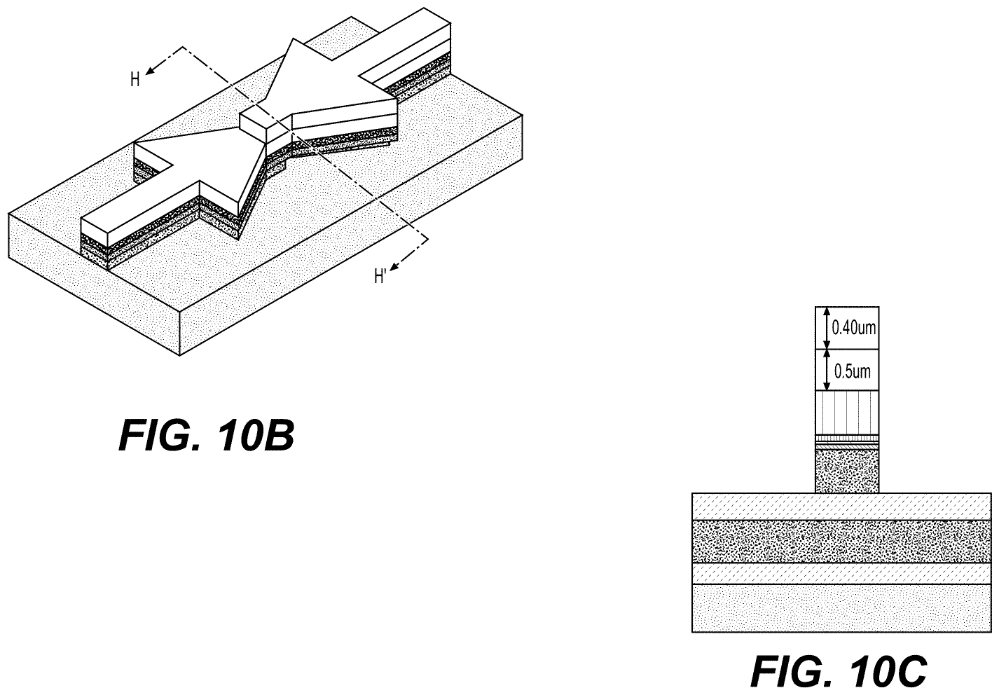

Next, an etch is done through feedstock 103. FIG. 10 illustrates the structure of rectenna 1300 with polymer layers left behind after the etch through the whole feedstock stack 103. This step can be accomplished, for example, by an RIE etch using a gas such as chlorine or by a combination of anisotropic wet and dry etches specific for the metals and diode layers.

In an embodiment that uses feedstock 103a of FIG. 1B, this accomplished in a series of etches as follows: Etch Al layer (layer (i) of feedstock 103a in FIG. 1B), essentially repeating step 4 to etch areas of the Al layer not previously etched. This Al etch is referred to as step 11 in the process flow chart of FIG. 29 and in Table 1. Etch Cr layer (layer (h) of feedstock 103a in FIG. 1B), essentially repeating step 5 to etch areas of the Cr layer not previously etched. Cr etch is referred to as step 12 in the process flow chart of FIG. 29 and in Table 1.

An RIE SF6 etch is used to etch NiO and Al₂O₃ layers (diode layers (f) and (g) of feedstock 103a in FIG. 1B). In an embodiment, the diode etch time is 30 seconds or approximately 30 seconds. In another embodiment wet etch is used to etch the oxide layers. Using a wet etch avoids a vacuum step at this point in the process. The diode layers etch is referred to as step 13 in the process flow chart of FIGS. 1B and 1n Table 1.

The Ni layer (layer (e) of feedstock 103a in FIG. 1B) is etched, essentially repeating step 8 to etch areas of the Ni layer not previously etched. The Ni etch is referred to as step 14 in the process flow chart of FIG. 1B and in Table 1.

Next, Al layer (layer (i) of feedstock 103a in FIG. 1B) is etched, essentially repeating step 4 to etch areas of this Al layer not previously etched. The Al etch is referred to as step 15 in the process flow chart of FIG. 29 and in Table 1. FIGS. 10 and 10B illustrate the result of etches through feedstock 103 and 103a respectively. FIG. 10C illustrates a cross section taken at line G-G′ in FIG. 10B of the result of the etches through feedstock 103a.

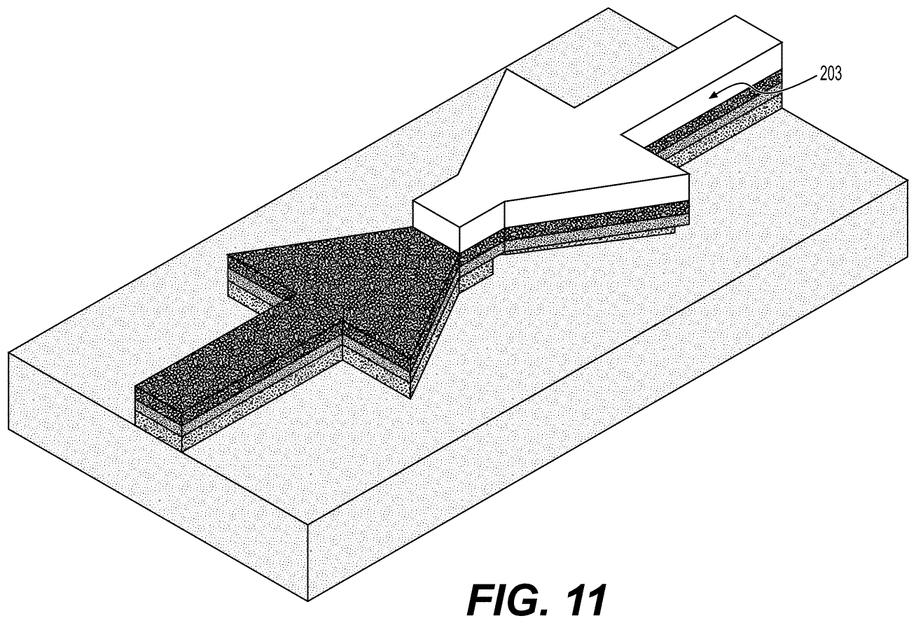

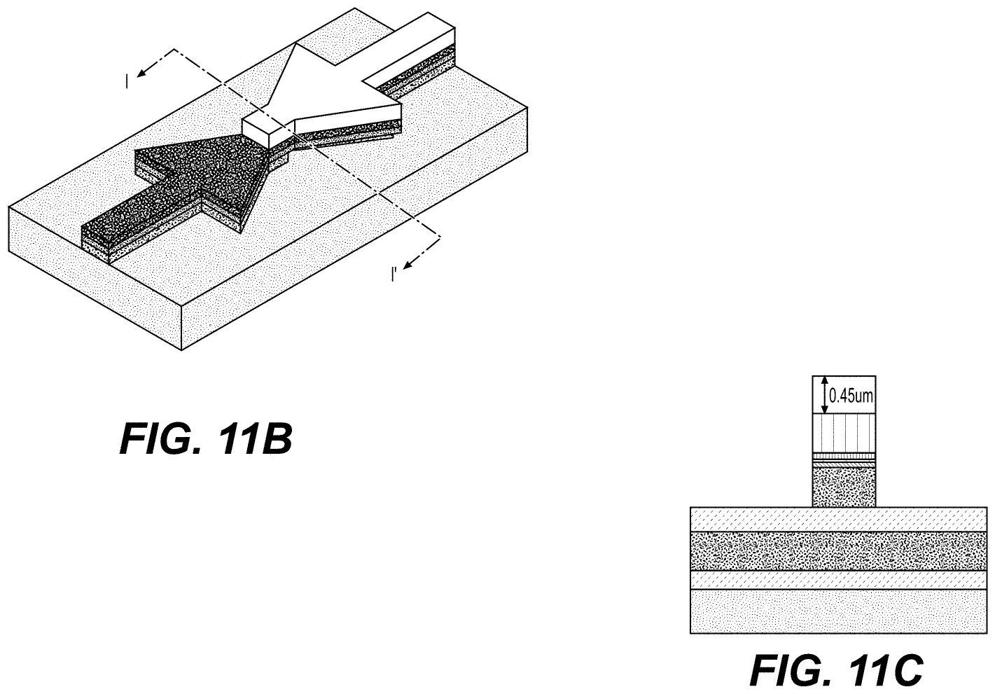

Next, as shown in FIG. 11, another layer of the polymer imprint template is removed leaving a remaining polymer imprint structure on the right antenna leaf 203 of nanoimprint tool 101. Thus, the photopolymer is removed over lower antenna arm 1302a. The left antenna leaf 204 of nanoimprint tool 101 is still not complete since it contains a full diode stack including metal 107, M2, diode oxides 108 and lower metal 109, M1. This anisotropic etch can be accomplished by an RIE process using, for example, an oxygen plasma. This is essentially a repeat of step 10. This removal of a layer of nanoimprint tool 101 is referred to as step 16 in the process flow chart of FIG. 29 and in Table 1. FIGS. 11 and 11B illustrate the result of removing polymer of nanoimprint tool 101 in region 204. FIG. 11C illustrates a cross section taken at line H-H′ in FIG. 11B of the result of removing polymer in region 204.

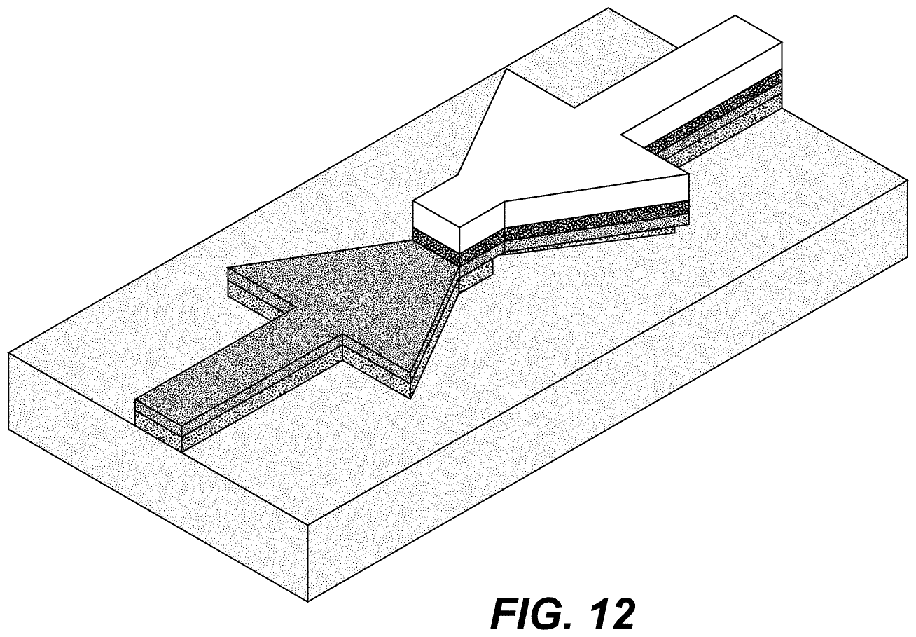

Next, as illustrated in FIG. 12 an etch removes the top metal from the left antenna leaf of metal 107, M2, that was under polymer region 204. Oxide layers 108 are shown to remain on this figure. Depending on the etch to remove metal 107, M2, these very thin oxides may be removed or remain. Because they are so thin, the existence of oxide layers 108 in this area has no impact to the device. This anisotropic etch can be accomplished either by wet etch which is specific to metal 107, M2, or by an RIE etch (such as a chlorine plasma) timed to end after metal 107, M2, is removed. This is essentially a repeat of Al etch step 4 for layer (i) of feedstock 103a in FIG. 1B under region 204. This Al etch is referred to as step 17 in the process flow chart of FIG. 29 and in Table 1.

In an embodiment using feedstock 103a, the Cr layer is also etched, which is essentially a repeat of step 5 for layer (h) of feedstock 103a in FIG. 1B. This Cr etch is referred to as step 18 in the process flow chart of FIG. 29 and in Table 1.

Next, as illustrated in FIG. 13, the remaining portion of nanoimprint tool 101 polymer is removed leaving the final version of the rectenna 1300. This final removal of the polymer can be accomplished by, repeating the process of step 10, using an oxygen plasma etch (such as ashing) or by a wet etch with a chemical which dissolves the polymer.

Removal of the remaining portion of nanoimprint tool 101 is referred to as step 19 in the process flow chart of FIG. 29 and in Table 1. FIGS. 13 and 13B illustrate the result of removing the remainder of nanoimprint tool 101. FIG. 13C illustrates a cross section taken at line I-I′ in FIG. 13B of the result of removing polymer in region 204.

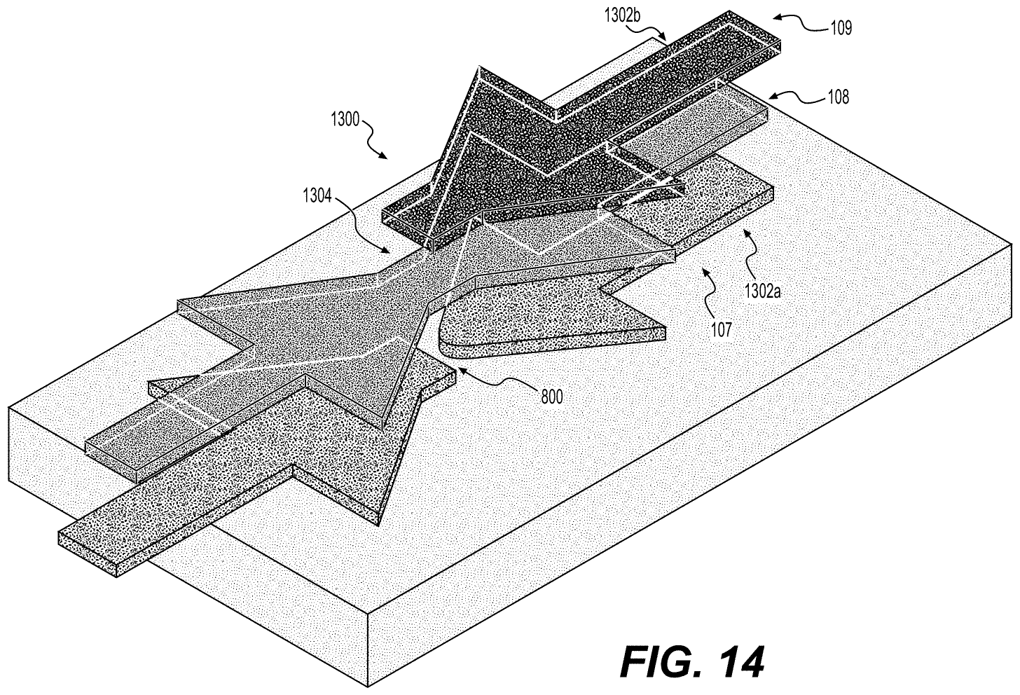

FIG. 14 illustrates an exploded view of the rectenna structure 1300 so that undercut 800 is visible. Quality assurance testing can be done at this point to determine device yield, and manufacturing efficiency.

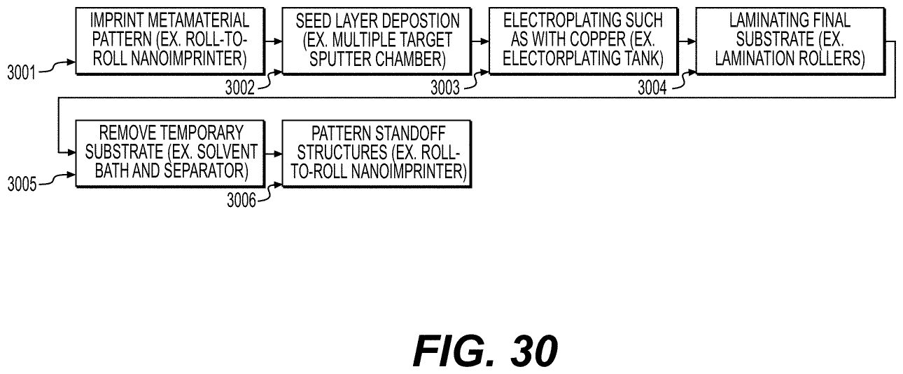

In an embodiment, the metamaterial material to be made comprises a series of patterned or unpatterned holes or posts on its surface. In the embodiment illustrated, the metamaterial comprises copper that has a patterned (periodic) series of holes on its surface. The metamaterial film subassembly comprises a plurality of such metamaterials. For manufacture of the metamaterial, the second subassembly, the following major process steps are performed:
Step 3001 (see FIG. 30): Imprint an electroplating template using an imprint polymer or monomer
Step 3002 (see FIG. 30): Deposit a seed layer onto the plating template to accommodate the electroplating
Step 3003 (see FIG. 30): Complete the electroplating by plating up and around the template.
Step 3004 (see FIG. 30): Laminate a thermally conductive substrate onto the top of the plated metal.
Step 3005 (see FIG. 30): Delaminate the temporary substrate and remove all remaining imprint polymer/monomer from the metamaterial.
Step 3006 (see FIG. 30): Pattern standoff pillars to prepare for alignment and bonding with rectenna film.

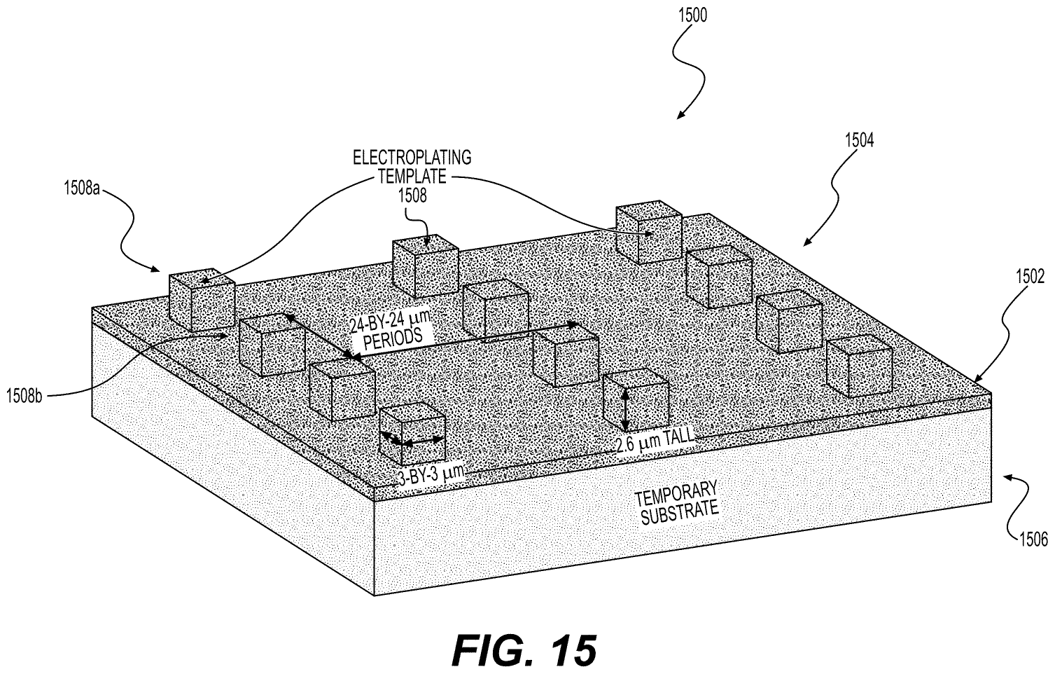

FIG. 15 illustrates a structure 1500 that comprises an electroplating template or imprint pattern 1501 for the electroplating step. In step 3001, using a transparent imprint tool, a polymer or monomer 1504 is imprinted, and UV cured onto a temporary substrate 1506. In a embodiment, temporary substrate 1506 is a portion substrate used in roll-to-roll processing. FIG. 15 shows just one of many repeating structures 1500 on the substrate sheet.

In an embodiment, polymer or monomer 1504 is UV curable and capable of forming and curing the geometry shown in FIG. 15. A scum layer 1502 below imprint pattern 1508 does not need to be removed. It will be used in a later step as a release layer.

In an embodiment, imprint pattern 1508 is characterized by a periodic placement of structures, such as structures 1508a and 1508b. In the embodiment illustrated in FIG. 15, the structures are posts that are arranged periodically in 24 um-by-24 um periods, that is, each structure is separated on each of its four sides from its nearest neighbor by 24 um. In the embodiment, shown, the structures have a square shape, each side being 3 um, and are 2.6 um tall. This structure arrangement, size, and shape will result in a metamaterial that will resonate at the Terahertz frequencies of the rectenna to which it will be bonded.

In alternative embodiments, the structures do not have to have periodic displacement, have the same size, or the same shape. Instead, the structures must have a shape and placement with respect to one another such that the resulting metamaterial will be resonant at the frequency to which the rectenna to be used is tuned.

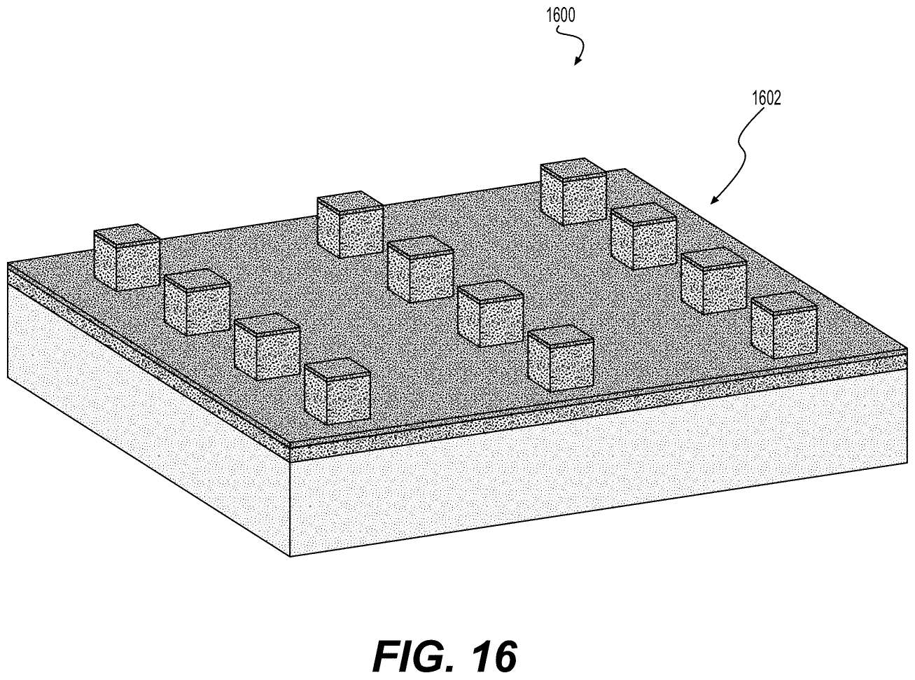

Once the plating template is completed, in step 3002, a seed metal 1602 is deposited to provide an electrically continuous path for plating to be carried out. This metal should be stable in the plating electrolyte and sufficiently conductive so that plating occurs homogeneously across the roll. In an embodiment, the seed layer material is copper that is sputtered at a rate of 2 nm/s to a thickness of 100 nm. All sections of the roll must be exposed to the copper evaporation for 50 seconds assuming this deposition rate. FIG. 16 illustrates a section of a film roll or substrate sheet 1600 that corresponds to structure 1500 after the seed layer is deposited. In FIG. 16, the sidewalls of the plating template structure have not been deposited. However, some sidewall deposition can be tolerated.

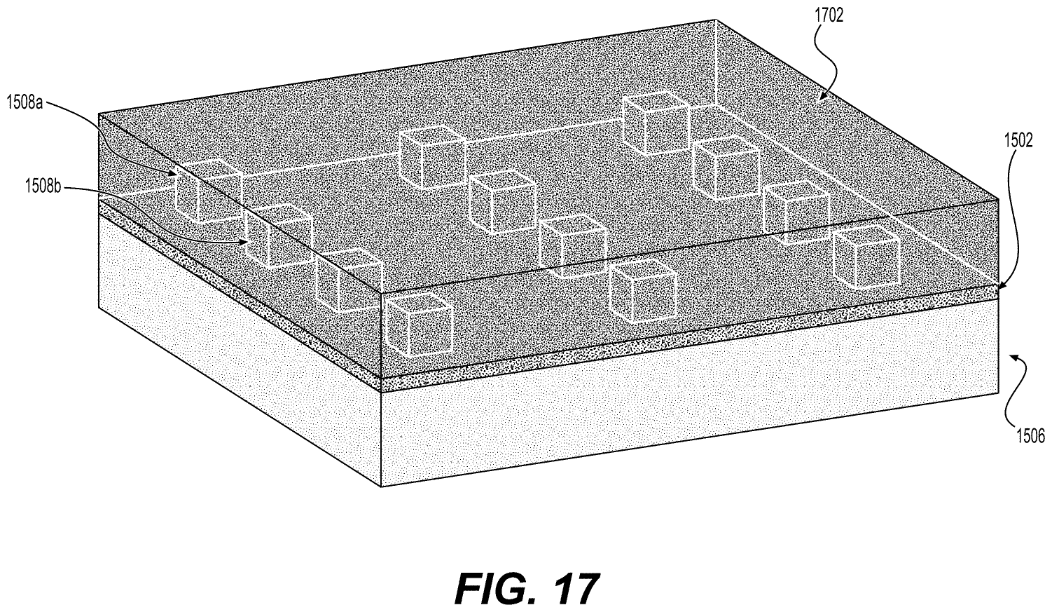

In step 3003, the material comprising the metamaterial is plated with the metamaterial material to fully encapsulate the plating template structures. In an embodiment, the metamaterial is copper. In such an embodiment, where copper is the metamaterial, in step 3003, After the seed layer has been deposited, plating of the copper is carried out to fully encapsulate the plating template structures. In an embodiment, electrical continuity needs to be made to the seed layer in order to drive a current density of 20 mA/cm². This electrical continuity can be made by direct contact to the top side of the structure towards the edges of the roll. The plating electrolyte comprises primarily copper (II) sulfate pentahydrate and sulfuric acid. The solution is very acidic with a pH of −0.25. The target plating thickness should extend past the structures. The current target thickness for wafer production of metamaterial is greater than 2× the template structure height for a total of 6 μm. With a plating deposition rate of approximately 7 nm/s the total deposition time of a single area of the roll is approximately 15 minutes. This time could be potentially decreased by a combination of increasing current density or setting the target thickness to a lower value. It is only important that the template is fully encapsulated. Therefore, the target thickness could be cut nearly in half if the plating across the roll is very homogeneous. FIG. 17 illustrates structures, such as structure 1508a and 1508b that have been completely plated by a plating material 1702 such as copper. It should be noted that an acceptable imprint polymer will not be affected by the plating process.

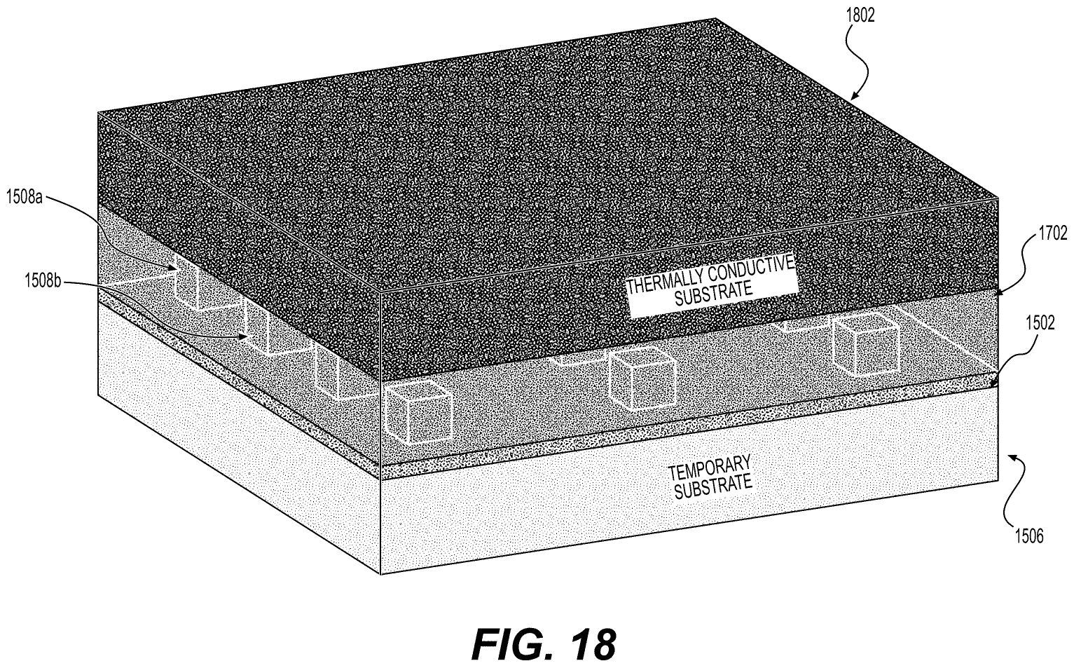

In step 3004, a substrate 1802 is added to the metamaterial being formed. In an embodiment, patterned side of the copper metamaterial is made face down. Making the patterned side of the copper metamaterial facedown reduces the precision tolerance of the electroplating depth and ensure a flat metamaterial surface. The metamaterial is required to have its openings facing the rectennas (when ultimately aligned and bonded to the rectenna, such as rectenna 1304). The plated structure in FIG. 17 needs to be flipped with respect to its substrate. This can be accomplished by first bonding the copper to a thermally conductive sheet, stainless steel for example as a substrate 1802. FIG. 18 illustrates a metamaterial comprising copper with a surface of period holes facedown with a substrate 1802 bonded to an opposite side of the copper.

In an embodiment, the material for the thermally conductive substrate 1802 can be chosen from any common metal. For instance, any of a variety of metals commonly used as roll-to-roll substrates are acceptable. In an embodiment, the bonding method for substrate 1802 uses bonds that are tolerant of temperatures up to 300° C.

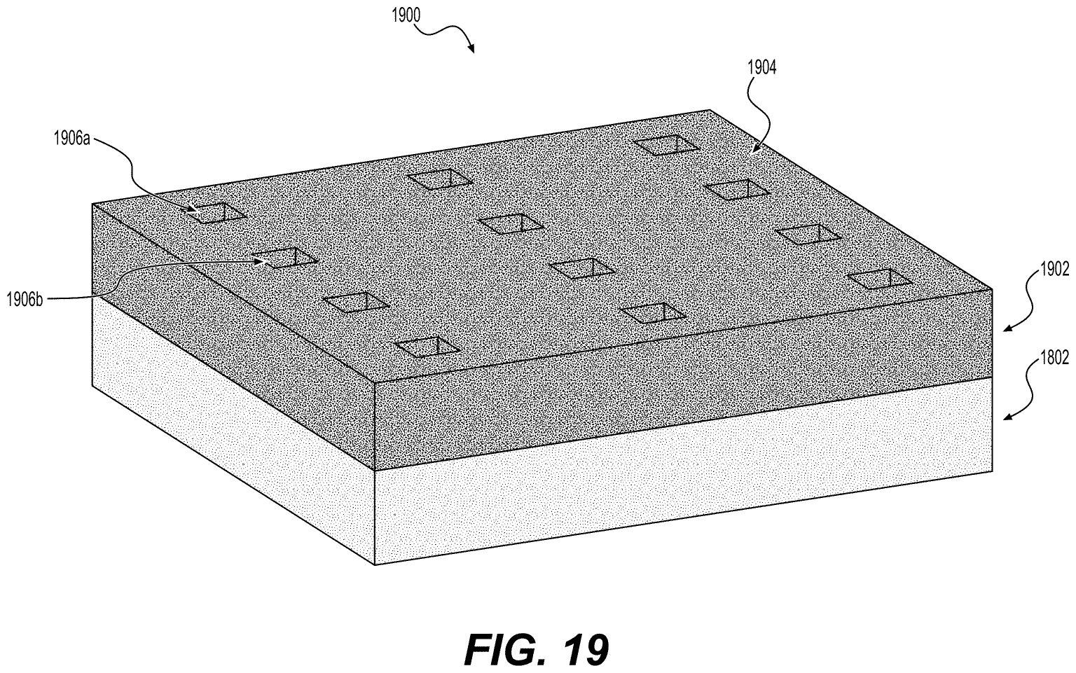

After substrate 1802 is attached to the top of the plated copper, the film is submerged in a solvent that will remove imprint polymer 1504 in step 3005. Removal of imprint polymer 1504 also results in detachment of temporary substrate 1506. In an embodiment, the solvent quickly and cleanly removes the polymer/monomer. All materials in the final metamaterial structure need to be thermally conductive and low outgassing for vacuum compatibility. As shown in FIG. 19, the result of this process is the finalized metamaterial 1900 that has been flipped to illustrate a copper material 1902 having a surface 1904 with a periodic arrangement of holes, such as holes 1906a and 1906b.

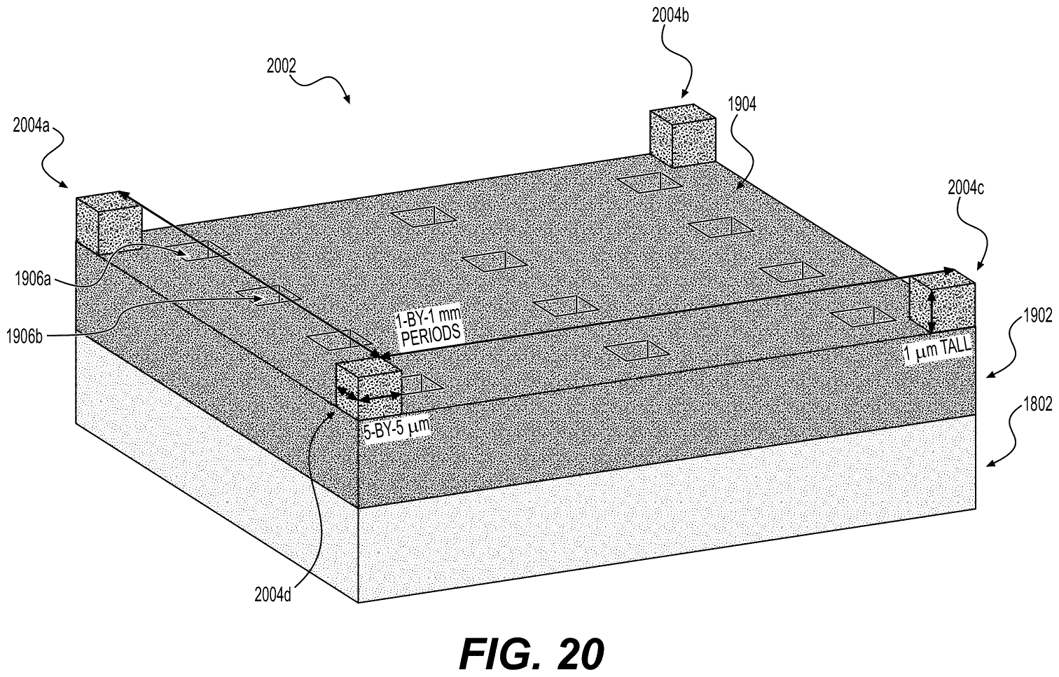

In step 3006, standoff structures are built onto surface 1904 of metamaterial 1900. Before aligning and bonding the metamaterial and rectenna films, standoff pillars are built on the surface of the metamaterial to set the separation distance between the two films. FIG. 20 illustrates an exemplary completed structure 2002 after the standoff structures 2004a, 2004b, 2004c, and 2004d have been added to metamaterial surface 1904. In an embodiment, the distance between each standoff structure 1904a, 1904b, 1904c, and 1904d is set at 1 mm and therefore alignment of the standoff structure pattern to the rest of the metamaterial structure is not necessary. In an embodiment, each standoff structure has a square shape with each side measuring Sum, and a height of 1 um. In an embodiment, the standoff structures, such as standoff structure 1904a, 1904b, 1904c, and 1904d are made from and patterned by using a UV sensitive polymer that has been exposed and developed. In an embodiment, the UV sensitive polymer is compatible with high temperatures that the metamaterial will see.

In an embodiment, there can be more than or fewer than 4 standoff structures of any shape and placement to provide the required distance between the rectenna and metamaterial films that will be aligned and bonded together.

Although manufacture of only a single rectenna and associated metamaterial device have been described, using the roll-to-roll manufacturing disclosed herein, numerous such devices will be able to be manufactured at a time using the roll-to-roll processes described above. In operation, as described in the '299 patent application and '051 patent application, in the presence of heat, electric fields are generated over the holes in the metamaterial. Rectennas that are tuned to the frequencies of those electric fields will generate an electric current when placed over them. Consequently, proper alignment is required to ensure that the rectenna film places the rectennas over the holes in the metamaterials when the rectenna film and metamaterial film are bonded to one another.

Manufacture of ACT film involves creating two subassembly films, a rectenna film comprising a plurality of rectenna 1304, and a metamaterial film comprising plurality of metamaterials 1900, as described above, aligning them, and bonding them together. The alignment of structures on these surfaces is critical to operation and must be performed to +/−250 nm precision.

There are several alignment techniques available in industry and literature. Those techniques mainly fall into three categories. In geometric imaging, two geometric marks are compared through and optical microscope. This technique is limited to the optical diffraction limit of the objective lens. However, the image resolution does not meet the alignment specification noted above. In an intensity-based detection method, the critical intensity values of diffracted beams from alignment grating marks are measured. This method can be sensitive to the alignment of the light source and the detection sensors with respect to the alignment marks. Calibrating the laser source and detection sensors position relative to the films is quite complex especially in a dynamic system. A third method, is a phase-based detection method, in which the phase of a beat signal from two diffracted beams of slightly different periods is measured. Misalignment is captured by imaging the diffracted field into a microscope-type system. Generally, the nano-scale shifts at the mask-wafer level maps to a large-scale diffraction variations that are easy to detect and process by a high resolution optical system. Depending on the type of source used and the nature of the misalignment to be captured, a diffraction scheme is selected.

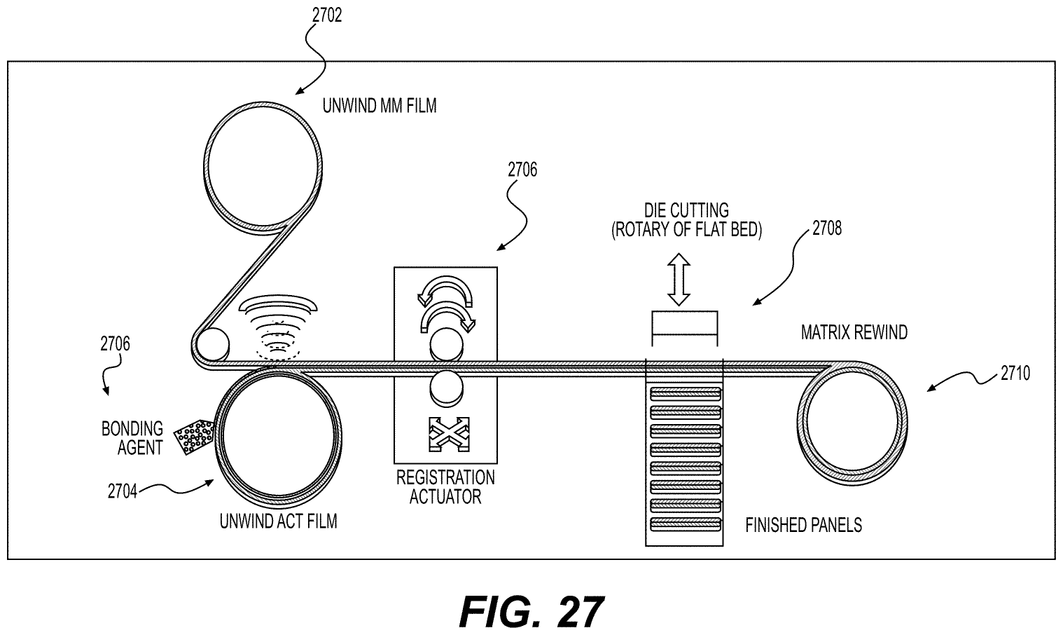

Embodiments of the present invention perform alignment as a roll-to-roll process using a Moiré technique discussed below. This is an optical method involving the use of alignment marks on each film layer. At least one film layer would need to be transparent for this method to be employable. Optical CCD sensors and computer driven controlled stepper motors close the feedback loop to affect continuous alignment. As shown in FIG. 27, alignment is performed as the films move toward press rollers where adhesive on top of the standoff structures ensures the bond.

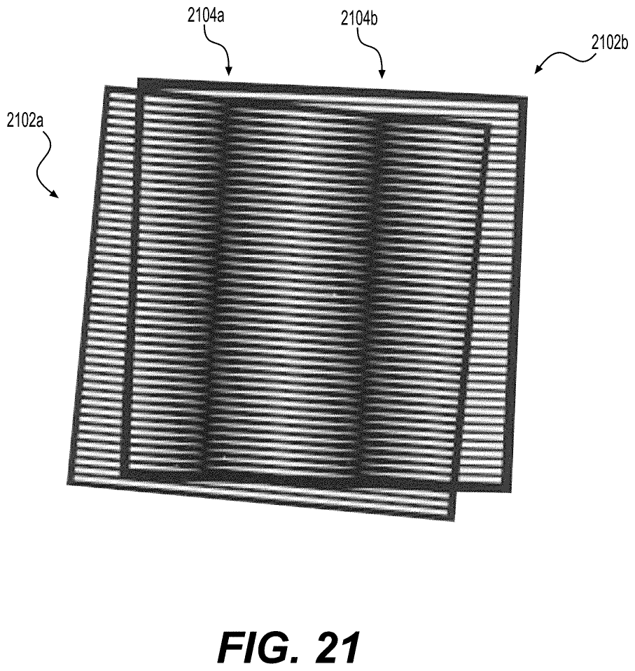

Moiré fringes are large scale interference patterns that can be produced when an opaque lined pattern with transparent gaps is overlaid on another similar pattern. For the Moiré interference pattern to appear, the two patterns are not completely identical, they must be displaced, rotated, have different, but close pitch. Moiré fringes can be detected by an optical system and a CCD. Using computer assisted codes, one can predict misalignment in the nanoscale from sub-micron scale (optical) images. FIG. 21 demonstrates one way of obtaining Moiré fringes, that is, rotation between two sets of grating lines. As shown in FIG. 21, when the images are properly aligned dark vertical, lines 2104a and 2104b, the Moiré fringes appear when the Moiré patterns 2102a and 2102b are overlaid upon one another. The Moiré fringes are due to superimposed fine gratings with a relative offset angle.

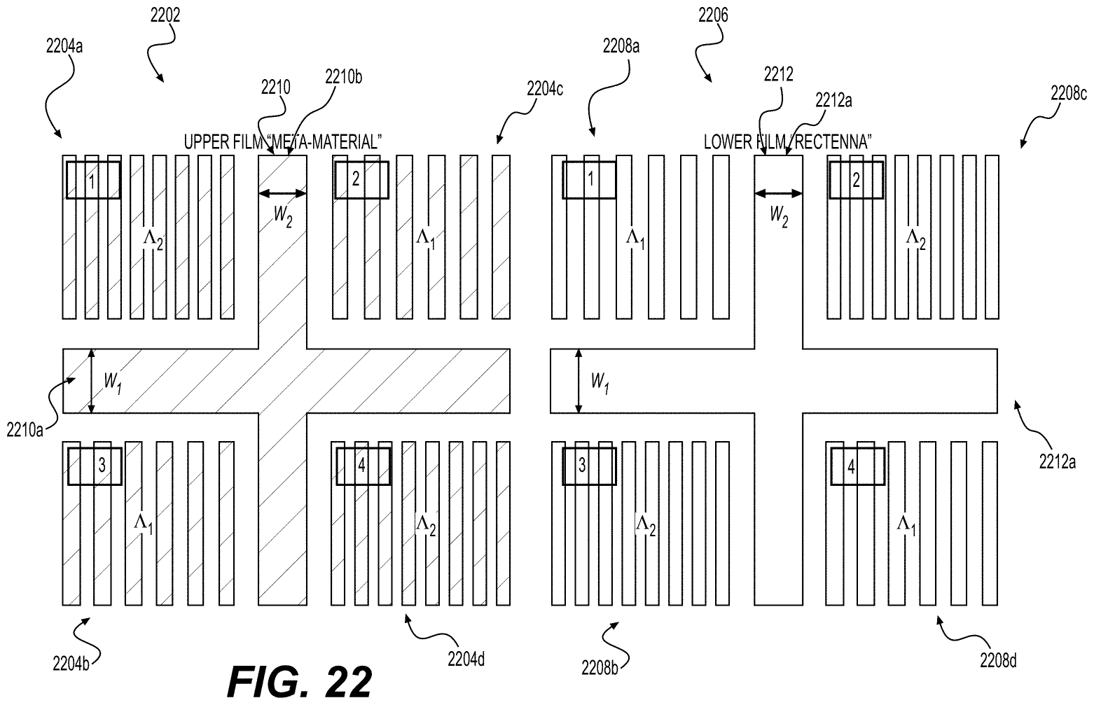

In an embodiment, alignment is performed using a combination of geometric imaging and phase-based detection described above with a Moiré pattern detection to achieve a sub-200 nm alignment between the metamaterial film and the rectenna film. In an embodiment, an alignment mark comprises four (4) sets of gratings with alternating pitches Λ₁ and Λ₂. FIG. 22 illustrates an exemplary rectenna alignment mark 2202 for the rectenna film that comprises 4 sets of gratings 2204a, 2204b, 2204c, and 2204d with alternative pitches Λ₁ and Λ₂, and an exemplary metamaterial alignment mark 2206 for a corresponding metamaterial film that comprises 4 sets of gratings 2208a, 2208b, 2208c, and 2208d with alternating pitches Λ₁ and Λ₂. When the metamaterial film is aligned to the rectenna film, sets 2204a, 2204b, 2208a, and 2208b will form complimentary grating patterns. Similarly, when the metamaterial film is aligned to the rectenna film, sets 2204c, 2204d, 2804c, and 2804c will form complimentary grating patterns. In the center rectenna alignment mark 2202, is a cross mark 2210 made of a wider trace is used for initial coarse alignment in the vertical and horizontal directions. Similarly, In the center rectenna alignment mark 2206, is a cross mark 2212 made of a wider trace is used for initial coarse alignment in the vertical and horizontal directions. Cross mark 2210 has two axes, one of which axis 2210a has a width w₁ and the other of which, axis 2210b, has a width w₂. Similarly, cross mark 2212 has two axes, one of which 2212a has a width w₁ and the other of which 2212b has a width w₂.

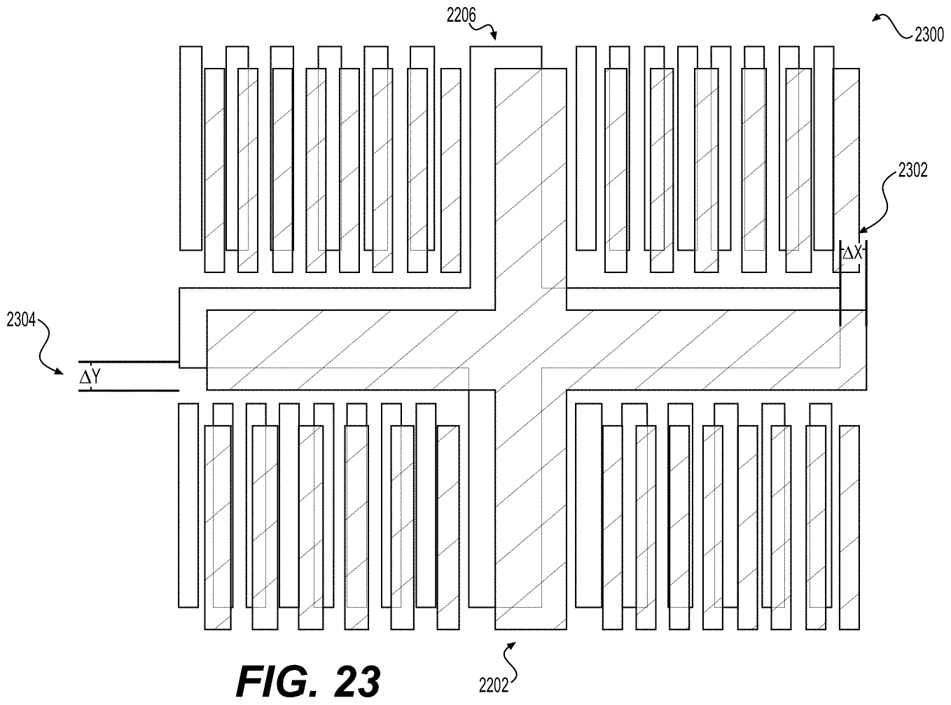

A broadband light source, such as LEDs, images identical Moiré patterns of the complimentary sets on a CCD sensor. A misalignment between the films results in a magnified phase shift between the Moiré patterns of the complimentary sets. Let the lateral grating misalignment be defined in the x and y directions as Δx and Δy, and the corresponding phase-shift in the observed Moiré patterns defined in the x and y directions as ΔX and ΔY. Then the magnification factor M, that is ΔX/Δx, or alternatively ΔY/Δy, is inversely proportional to the difference between Λ₁ and Λ₂ as follows,

$$M = \frac{{Λ}_{2}}{Δ Λ}$$

where ΔΛ is the difference between Λ₁ and Λ₂. A 5% relative difference between Λ₁ and Λ₂ is equivalent to a magnification factor M of 20×. A substantial benefit of this approach is the detected ΔX and ΔY is independent of the relative position of the light source and the optics to the alignment marks. One important caveat is that that Moiré patterns are identical after full period shift Λ₁. Hence, there is a need for an initial coarse alignment using geometric imaging methods. The initial coarse alignment is applied to the inner cross marks “+” 2210 and 2210 shown in FIG. 22. The coarse alignment should overlap the grating sets 2202a, 2202b, 2202c, and 2202d and 2208a, 2208b, 2208c, and 2208d (sets 1-4 as illustrated) within a Λ₁ accuracy. Such a coarse alignment is illustrated in FIG. 23, wherein the offset in the x-direction 2302 and the offset in the y-direction 2304 are less than or equal to Λ₁. A first estimate of the dimensions would be as follow: w₁=w₂=4 um, Λ₁=1 um, and Λ₂=0.95 um. Note, the coarse alignment cross marks do not have to align exactly. They need only align within a □₁ accuracy.

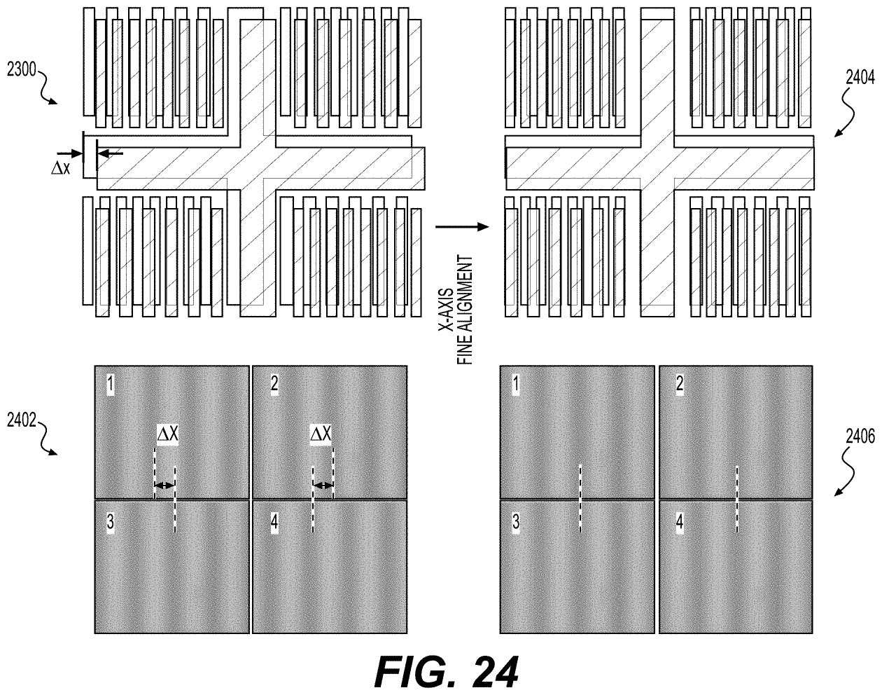

After coarse alignment, a CCD captures Moiré the ΔX shift in the fringes as illustrated for example, Moiré fringes 2402 associated with coarse alignment 2300 in FIG. 24. The information is fed to a microcontroller that adjusts the x-position of one of the films via a step motor until alignment is achieved. Such fine alignment in the x-direction is illustrated in Moiré fringes 2408 associated with aligned x-position grating sets 2404 illustrated in FIG. 24.

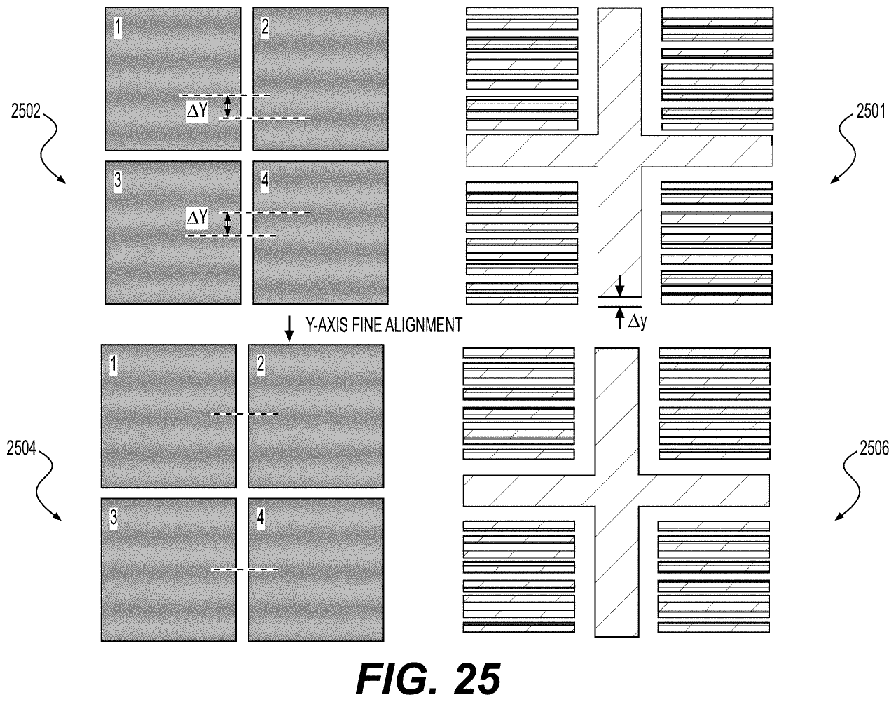

After fine alignment in the x-direction, the CCD captures the ΔY shift in the Moiré fringes as illustrated for example, Moiré fringes 2502 associated with a y-direction grating in the fine x-direction alignment 2501 in FIG. 24. The information is fed to a microcontroller that adjusts the y-position of one of the films via a step motor until alignment is achieved. Such fine alignment in the y-direction is illustrated in Moiré fringes 2504 associated with the fully aligned y-direction grating sets 2506 illustrated in FIG. 25. At this point, alignment to within the required precision is achieved.

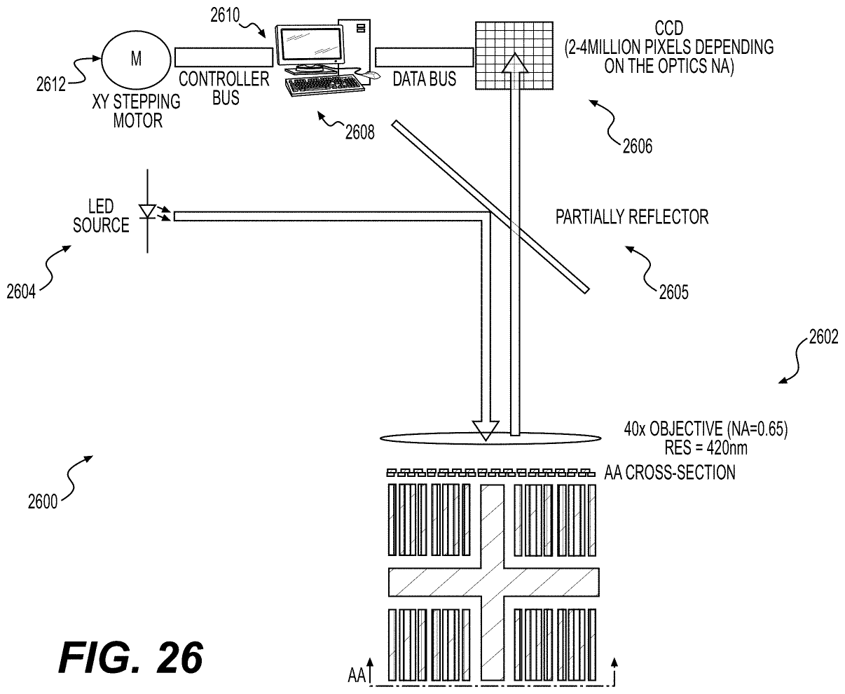

FIG. 26 is a schematic of an alignment system 2600 for aligning a rectenna film and a metamaterial film according to an embodiment. System includes a microscopic optical system 2602 with LED illumination 2604. In an embodiment, the optical magnification of microscopic optical system 2602 is 40×. A reflector 2505 directs light emitted from LED 2604 to the rectenna and metamaterial films to illuminate the grating sets to capture Moiré fringe patterns. Reflector 2505 allows the illuminated Moiré fringe patterns to reach a CCD array 2606, which captures Moiré fringe images for fine alignment in the x- and y-directions. In an embodiment, CCD array 2606 has 4 mega-pixels resolution. System 2600 further includes a computer 2608 to process the Moiré patterns, a micro-controller 2610 (and/or alternatively Labview) to control an XY step motor 2612 to align the rectenna and metamaterial films.

FIG. 27 is a schematic diagram of an exemplary roll-to-roll system 2700 that incorporates an alignment system, such as alignment system 2600 configured to operate in a roll-to-roll environment. A metamaterial film roll 2702 comprising metamaterial formed as described above and a rectenna film roll 2704 comprising rectennas formed as described above are fed past a registration actuator 2706 that aligns metamaterial film roll 2702 and rectenna film roll 2704 as described above to ensure the rectenna are located over the holes in the metamaterial. Once aligned, the metamaterial film is bonded to the rectenna film using a bonding agent 2707. Rewinding of the metamaterial and rectenna films when required is performed using a rewind spool 2710. When the alignment and bonding are complete finished panels are made using die cutting tool 2708.

An alternate method of alignment involves use of the power output signature of the rectenna film as the metamaterial and rectenna films are placed in casing structures. Power bus output is passed through an A/D converter and delivered to a computer workstation running a power and positioning optimization algorithm. Control of the relationship between the metamaterial and rectenna films is made through a motorized linear stage by the optimization software. A few degrees temperature difference is required between the two films to generate a power output signal. Initial alignment in panel case will be sufficient to begin optimization hunting algorithm. A boustrophedonic search in 1 um steps will position the plates within proximity within at most 144 steps and on average 72 steps. Fine positioning can proceed with a simple “greedy” step and adjust or other similar algorithm to bring final alignment. Once alignment is complete, edged are bonded and panel is sealed.

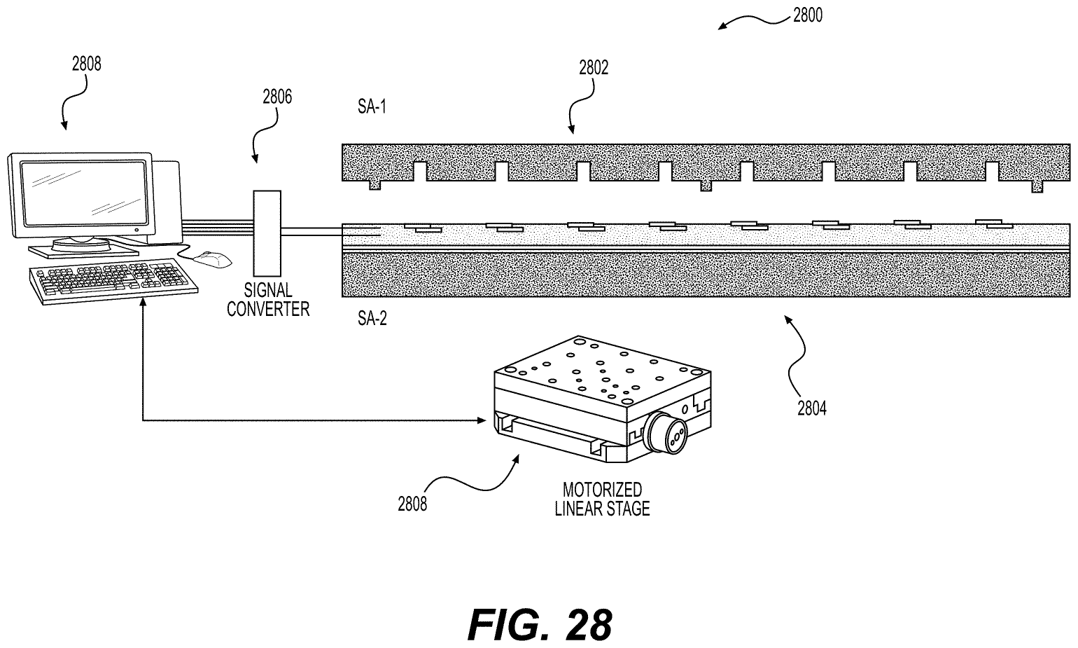

FIG. 28 is a schematic of an exemplary system 2800 for aligning a metamaterial film 2802 and a rectenna film 2804 according to an embodiment using power output signature alignment. Metamaterial roll 2802 and rectenna roll 2804 are fed through the roll-to-roll system. So, long as there is a temperature differential between the two films, the rectennas in rectenna layer 2804 will output electrical power. That output power is fed through an A/D converter 2806 to a computer 2808. Computer 2808 analyzes the output power, and controls a motor to align the metamaterial roll 2802 and rectenna roll 2804 until a maximum output power is found.

FIG. 29 is a flow chart for process for creating a rectenna film comprising a plurality of rectennas according to an embodiment as described above. The steps illustrated in FIG. 29 have been described in detail above.

FIG. 30 is a flow chart for a process that creates a metamaterial film comprising a plurality of metamaterials according to an embodiment as described above. The steps illustrated in FIG. 30 have been described in detail above.

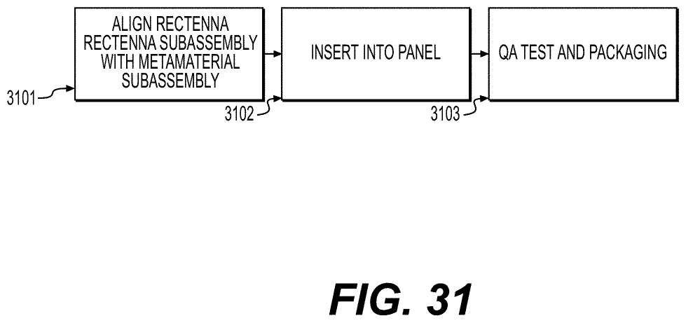

FIG. 31 is a flow chart for a process for final product assembly of the rectennas coupled with the metamaterials according to an embodiment, as described above. In step 3101, the rectenna film and the metamaterial film are aligned and bonded. In step 3102, the bonded rectenna-metamaterial assembly is submitted to a panel. Quality Assurance testing and packaging are performed in step 3103.

What is claimed is:

1. A method for fabricating an ACT film, comprising:
fabricating a rectenna film on a roll-to-roll substrate having a plurality of rectenna, wherein each rectenna comprises a first metal layer, a second metal layer, and at least one oxide sandwiched between the first and second metal layer to create a diode, where each rectenna is fabricated using a series of etches to a feedstock during which an undercut of the first metal is made to avoid a short circuit of the diode to the second metal;
fabricating a metamaterial film on a substrate having a plurality of metamaterials, each metamaterial having a plurality of holes on its surface;
aligning the rectenna film and the metamaterial films such that the rectennas are located over the holes in the metamaterials; and
bonding the rectenna film to the metamaterial film when they are aligned.

2. The method recited in claim 1, wherein fabrication of the metamaterial film comprises:
placing an electroplating template having a plurality of structures on a temporary substrate;
seeding the electroplating template;
plating the electroplating template to completely encapsulate the structure;
affixing a substrate; and
removing the temporary substrate.

3. The method recited in claim 1, further comprising placing standoff structures on the surface of the metamaterials prior to aligning the two films.

4. The method recited in claim 1, further comprising aligning the two films using Moiré fringes.

5. The method of claim 4, further comprising performing a coarse alignment and a fine alignment.

6. The method of claim 5, further comprising performing the coarse and find alignments in a both an x-direction and a y-direction.

7. The method of claim 1, wherein the undercut is made by using a timed wet etch of the first metal.

8. The method of claim 1, wherein each rectenna is fabricated using a nanoimprint tool to guide the series of etches.

9. The method of claim 8, wherein the nanoimprint tool is imprinted on the feedstock.

10. The method of claim 1, further comprising fabricating the feedstock by:
depositing the first metal layer on the substrate;
depositing the at least one oxide on the first metal layer a layer at a time for each oxide; and
depositing the second metal layer on the last oxide layer deposited.

11. The method of claim 10, further comprising building the nanoimprint tool on the second metal layer.

12. The method of claim 11, wherein the nanoimprint tool has an impression region.

13. The method of claim 12, wherein the undercut is formed by:
etching through the material of the nanoimprint tool in the impression region to expose the second metal layer;
etching through the second metal layer and at least one oxide in the impression region to expose the first metal layer; and
etching the first metal in the impression region with sufficient time for the undercut to form.

14. The method of claim 9, wherein the nanoimprint tool has an impression region.

15. The method of claim 14, wherein the undercut is formed by:
etching through the material of the nanoimprint tool in the impression region to expose the feedstock;
etching through the feedstock in the impression region to expose the first metal layer; and
etching the first metal in the impression region with sufficient time for the undercut to form.
